(19) United States
(12) Patent Application Publication
(10) Pub. No.: US 2026/0012095 A1
(43) Pub. Date: Jan. 8, 2026

(54) Apparatus with a Switch Arrangement and Method for Controlling the Same

(71) Applicant: Fraunhofer-Gesellschaft zur Förderung der angewandten Forschung e.V., Muenchen (DE)

(72) Inventor: Nico SCHMIED, Erlangen (DE)

(73) Assignee: Fraunhofer-Gesellschaft zur Förderung der angewandten Forschung e.V., Muenchen (DE)

(21) Appl. No.: 19/257,516

(22) Filed: Jul. 2, 2025

(30) Foreign Application Priority Data
Jul. 2, 2024 (DE) 102024206222.7

(51) Int. Cl. H02M 3/158; H02M 1/32

(52) U.S. Cl. CPC H02M 3/158; H02M 1/32

(57) ABSTRACT

An apparatus includes a switch arrangement with at least one switching element configured for cutting off an electric current path of a commutation circuit, wherein the commutation circuit comprises a free-wheeling element with a capacitance effective in parallel. A switchable circuit path is connected in parallel to the electric switching element or to the circuit path, having an electric capacitance element configured to influence, depending on a switching state of the switchable circuit path, the commutation resonant circuit differently. A means for driving is configured to switch, in a first operating state, the switchable circuit path into a first switching state and to control the switching element for cutting off and for carrying out a switching process, wherein, in the first switching state, the switching process is carried out on the basis of a first cut-off current, with a first current value, to be cut off. In a second operating state, the means for driving is configured to switch the switchable circuit path into a different second switching state and to control the switching element for cutting off and for carrying out the switching process with a second cut-off current.

### CROSS-REFERENCE TO RELATED APPLICATION

This application claims priority from German/European Patent Application No. DE 10 2024 206 222.7, which was filed on Jul. 2, 2024, and is incorporated herein in its entirety by reference.

The present invention relates to an apparatus with a switch arrangement including a switching element and to a method for controlling such an apparatus. Furthermore, the present invention relates to an adaptive control of capacitances and parasitic inductances for Zero Overvoltage Switching (ZOS).

### BACKGROUND OF THE INVENTION

In power electronics, there are countless topologies and circuits that switch on and off a current path with the help of a transistor or semiconductor switch. The current path to be switched consists of an electrical conductor and a conductor loop, which, due to the laws of nature, always forms a parasitic inductance. This inductance, typically in the range of 1 nH to 100 nH, prevents the switching process from taking place at any speed. With increasingly faster switching processes in the range of 1 ns to 1000 ns (depending on the power class), high cut-off (or turn-off) overvoltages occur at the switching element, particularly during cut-off.

EP 3 512 085 A1 describes a concept for switching a semiconductor switch with lower overvoltages.

This document describes that, by using Zero Overvoltage Switching, ZOS, it is possible to switch power semiconductors at high to maximum switching speeds without having to accept occurrence of high cut-off overvoltages. In EP 3 512 085 A1, this is possible for voltages only for a cut-off current including a tolerance range.

In DE 10 2022 210 134 A1, this concept is extended in that the operating range possible therein includes different cut-off currents that can be switched off using ZOS. The cut-off currents I_{TO,n} to be adjusted are determined by the intermediate circuit voltage V_{DC}, the parasitic inductance Lₚ and the parasitic capacitances C_{eff1} and C_{eff2}. DE 10 2022 210 134 A1 indicates this with cut-off currents according to:

$${I}_{TO , n} = \frac{{V}_{D C} \sqrt{\frac{{( {C}_{eff 1} + {C}_{eff 2} )}^{3}}{{C}_{eff 1} {C}_{eff 2} {L}_{p}}}}{n π} \qquad ( 1 )$$

wherein n=2i+1, i∈ [symbol] .

Although such a power-electronics converter system already achieves advantages, it is still only possible to address a limited number of cut-off currents and operate the system at them. Possibly, the largest operating range that cannot be directly covered is between the possible cut-off currents for n=1 and n=3. To this end, it is possibly necessary for the converter system to apply different operating modes. Although DE 10 2022 210 134 A1 already extends the operating range, the converter will still only be able to adjust the entire load range only by means of special operating modes via its discrete operating points.

FIG. 14 shows an exemplary current/voltage diagram for illustrating a range 1002 between the cut-off currents n=1 and n=3.

Thus, if a system is operated with ZOS (EP 3 512 085 A1) and extended ZOS area, eZOSa, (DE 10 2022 210 134 A1), operating ranges, in particular the range between I_{TO,1} and I_{TO,3}, may only be operated with special operating modes. Among other things, this includes valley skipping [1] or burst mode [2].

A further possibility is to build the converter system with several phases [3] and to switch on and off individual phases in different operating ranges. Parallelization of individual phases leads to the necessity of higher component efforts and increasing costs.

In the above-mentioned possibilities for setting varying operating points, the required cut-off current I_{TO,n} still has to be reached in order to be able to apply ZOS.

Thus, it would be desirable to enable additional operating conditions for as overvoltage-free or low-overvoltage and/or loss-free or low-loss switching as possible.

### SUMMARY

An embodiment may have an apparatus, comprising: a switch arrangement with at least one switching element configured for cutting off an electric current path of a commutation circuit, wherein the commutation circuit comprises a free-wheeling element with a capacitance effective in parallel; a switchable circuit path, connected or coupled in parallel to the electric switching element or to the circuit path, with an electric capacitance element configured to cause, depending on a switching state of the switchable circuit path, a different influence on the commutation resonant circuit, a driving unit configured to switch, in a first operating state, the switchable circuit path into a first switching state and to control the switching element for cutting off and for carrying out a switching process, wherein, in the first switching state, the switching process is carried out on the basis of a first cut-off current with a first current value, to be cut off; and switch, in a second operating state, the switchable circuit path into a second switching state and to control the switching element for cutting off and for carrying out the switching process, wherein, in the second switching state, the switching process is carried out on the basis of the second cut-off current, with a second current value, to be cut off.

Another embodiment may have a method for controlling an apparatus described herein, with a switch arrangement with at least one switching element equipped for cutting off an electric current path of a commutation circuit, wherein the commutation circuit comprises a free-wheeling element with a capacitance effective in parallel, comprising: controlling the switching element for cutting off and for carrying out a switching process; controlling a switchable circuit path with an electric capacitance element, connected in parallel to the electric switching element or the circuit path, so as to carry out, depending on a switching state of the switchable circuit path, a different influence on the commutation resonant circuit; so that, in a first operating state, the switchable circuit path is switched into a first switching state and the switching element is controlled for cutting off and for carrying out a switching process, wherein the switching process is carried out in a first switching state on the basis of a first cut-off current, with a first current value, to be cut off; and in a second operating state, the switchable circuit path is switched into a second switching state and the switching element is controlled for cutting off and for carrying out the switching process, wherein the switching process is carried out in a second switching state on the basis of a second cut-off current, with a second current value, to be cut off.

Another embodiment may have a non-transitory digital storage medium having a computer program stored thereon to perform the method for controlling an apparatus described herein, with a switch arrangement with at least one switching element equipped for cutting off an electric current path of a commutation circuit, wherein the commutation circuit comprises a free-wheeling element with a capacitance effective in parallel, comprising: controlling the switching element for cutting off and for carrying out a switching process; controlling a switchable circuit path with an electric capacitance element, connected in parallel to the electric switching element or the circuit path, so as to carry out, depending on a switching state of the switchable circuit path, a different influence on the commutation resonant circuit; so that, in a first operating state, the switchable circuit path is switched into a first switching state and the switching element is controlled for cutting off and for carrying out a switching process, wherein the switching process is carried out in a first switching state on the basis of a first cut-off current, with a first current value, to be cut off; and in a second operating state, the switchable circuit path is switched into a second switching state and the switching element is controlled for cutting off and for carrying out the switching process, wherein the switching process is carried out in a second switching state on the basis of a second cut-off current, with a second current value, to be cut off, when said computer program is run by a computer.

It is a core idea of the present invention to have realized that the cut-off current (or breaking current or cut-off current or turn-off current) for as overvoltage-free and/or low-loss switching as possible depends on effective capacitances and/or effective inductances and that an active temporal influence or manipulation of these parameters makes it possible to adapt the optimum resulting cut-off current by adapting the effective parameters. This helps obtaining an additional operating point for the cut-off current for a voltage to be provided.

According to an embodiment, an apparatus includes a switch arrangement with at least one switching element configured for cutting off an electric current path of a commutation circuit, wherein the commutation circuit comprises a free-wheeling element with a capacitance effective in parallel. Furthermore, a switchable circuit path, connected or coupled in parallel to the electric switching element or to the circuit path, having an electric capacitance element is arranged, wherein the electric capacitance element is configured to cause, depending on a switching state of the switchable circuit path, a different influence on the commutation resonant circuit. A driving unit (or means for driving) of the apparatus is configured to switch, in a first operating state, the switchable circuit path into a first switching state and to control the switching element for cutting off and for carrying out a switching process, wherein, in the first switching state, the switching process is carried out on the basis of a first cut-off current, with a first current value, to be cut off. In a different second operating state, the driving unit is configured to switch the switchable circuit path into a different second switching state and to control the switching element for cutting off and for carrying out the switching process, wherein, in the second switching state, the switching process is carried out on the basis of the second cut-off current, with a second current value, to be cut off. By changing the switching state, a different influence of the commutation circuit may be caused, resulting in a mutually different optimum cut-off current of the commutation circuit with respect to ZOS, which makes it possible to provide additional operating points.

According to an embodiment, a method that may be used for controlling an apparatus described herein with a switch arrangement with at least on switching element configured for cutting off an electric current path of a commutation circuit is provided. The commutation circuit comprises a free-wheeling element with a capacitance effective in parallel. A step includes controlling the switching element for cutting off and for carrying out a switching process. The method includes controlling a switchable circuit path with an electric capacitance element, connected in parallel to the electric switching element or the circuit path, to carry out, depending on a switching state of the switchable circuit path, a different influence on the commutation circuit. The method is carried out such that, in a first operating state, the switchable circuit path is switched into a first switching state and the switching element is controlled for cutting off and for carrying out a switching process, wherein, in a first switching state, the switching process is carried out on the basis of a first cut-off current, with a first current value, to be cut off. In a second operating state, the switchable circuit path is switched into a second switching state and the switching element is controlled for cutting off and for carrying out the switching process, wherein, in the second switching state, the switching process is carried out on the basis of a second cut-off current, with a second current value, to be cut off.

### BRIEF DESCRIPTION OF THE DRAWINGS

Embodiments of the present invention will be detailed subsequently referring to the appended drawings, in which:

FIG. 1a shows a schematic block circuit diagram of a known apparatus;

FIG. 1b shows a further schematic block circuit diagram of the apparatus, wherein a parasitic inductance is divided into two different parasitic inductances;

FIG. 2 shows a schematic block circuit diagram of an apparatus according to an embodiment;

FIG. 3 shows a schematic block circuit diagram of an apparatus according to an embodiment, comprising a switchable circuit path for the adaption of inductance;

FIG. 4 shows a schematic block circuit diagram of an apparatus according to an embodiment, with a plurality of switchable circuit paths for the adaption of inductance;

FIG. 5 shows a schematic block circuit diagram of a simulation proof of embodiments described herein and in connection with a circuit for the adaption of inductance;

FIG. 6a-b each show, among other things, a comparison of gate voltages in a semiconductor circuit according to embodiments;

FIG. 7 shows a schematic illustration to highlight the inventive advantages with an adaption of inductance for obtaining additional operating points;

FIG. 8a-b show schematic illustrations of graphs to illustrate the influence of the cut-off current with inventive circuits;

FIG. 9a-d show exemplary illustrations of measurement results for cutting off a cut-off current I_{TO,3};

FIG. 10 shows a schematic block circuit diagram of an apparatus according to an embodiment, with a circuit path for adapting an effective capacitance;

FIG. 11 shows a variation of FIG. 7 for capacitive adaption in the context of the embodiments;

FIG. 12 shows an exemplary schematic illustration for a mutual implementation of adaption of capacitance and adaption of inductance according to an embodiment;

FIG. 13 shows a schematic flow diagram of a method according to an embodiment; and

FIG. 14 shows an exemplary current/voltage diagram to illustrate operating points of a known apparatus.

### DETAILED DESCRIPTION OF THE INVENTION

Before embodiments of the present invention are subsequently described in detail on the basis of the drawings, it is to be noted that identical, functionally identically elements, objects and/or structures or elements, objects and/or structures having the same effect are provided with the same reference numerals in the different drawings so that the description of these elements illustrated in different embodiments is interchangeable or can be applied to one another.

Subsequently described embodiments are described in connection with a multitude of details. However, embodiments may also be implemented without these detailed features. In addition, embodiments, for the sake of clarity, are described using block circuit diagrams to replace a detailed illustration. Furthermore, details and/or features of individual embodiments may readily be combined as long as not explicitly noted otherwise.

Subsequent embodiments relate to switching, in particular cutting off, a switching element. Some of the embodiments particularly refer to the use of a semiconductor switch as a switching element, wherein the embodiments are not limited thereto. As an alternative or addition to a semiconductor switch, other switching elements configured for switching between a conductive and a non-conductive state, such as relays or MEMS relays, transistors, e.g. configured based on carbon nano tube (CNT) materials and/or diamond materials, may be arranged. Transistors may also be manufactured as MOSFET transistors or bipolar transistors and/or in any manufacturing technology different from MOS.

A possible field of application of such a switching element is a DC voltage converter, wherein current paths are switched off by using switching elements in other environments as well, e.g. for operating or deactivating loads. DC voltage converters may be configured to convert DC voltage with a first electric voltage level or potential to a second electric voltage level or potential, wherein the second level may be higher or lower than the first level. DC voltage converters may comprise a semiconductor switch that is switched by a driving unit (or means for driving).

Subsequent embodiments relate to switching processes in semiconductor switches. In the context of the embodiment described herein, they are linked to commutation processes in commutation circuits, e.g. in connection with DC voltage converters. That is, the commutation process may be triggered by the switching process. In this regard, in the context of some of the embodiments described herein, it may be synonymously stated that a switching process excites an excitation resonant circuit of the commutation circuit and that a commutation process triggered by the switching process excites the excitation resonant circuit of the commutation circuit.

Embodiments of the present invention relate to a concept for low-overvoltage or overvoltage-free switching, also referred to as Zero Overvoltage Switching, ZOS. Even though this term refers to the overvoltage as being zero, due to parasitic properties, there are remaining voltage peaks in real systems, however, which, using the present invention, may be so low that components may be operated without problems. Currently, it is often not possible to switch semiconductors fast enough, since the switching processes are decelerated by internal gate resistances, among other things.

At this point, particular reference is made to the ZOS-extended concept of DE 10 2022 210 134 A1, which is further improved by the present disclosure. Contrary to identifying additional switching currents for a circuit, as previously proposed in the prior art, the present invention relates to changing the underlying circuit, e.g. as a half-bridge circuit, and to realize the same differently in the different switching states with the help of a switchable switching path that may be brought into different switching states so that different parameters of the effective capacitance and/or of the effective inductance including the parasitic inductances or being formed thereof are effective for the commutation circuit.

Numerical values for voltages, overvoltages, times and/or cut-off currents mentioned in connection with embodiments and in particular for simulations result in values that may be achieved or set with real implementations of embodiments, however, which do not limit embodiments. It is understood that changes in the circuit may lead to changes in values.

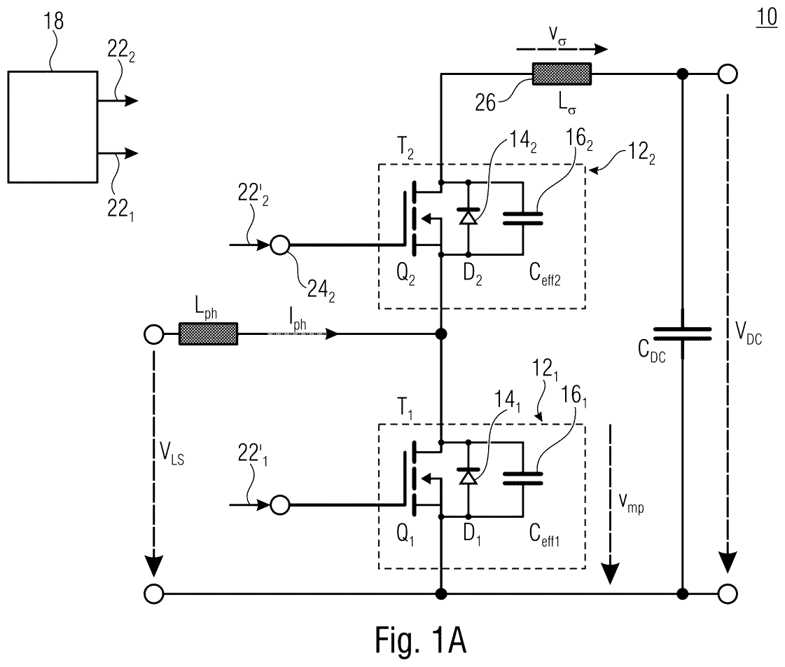

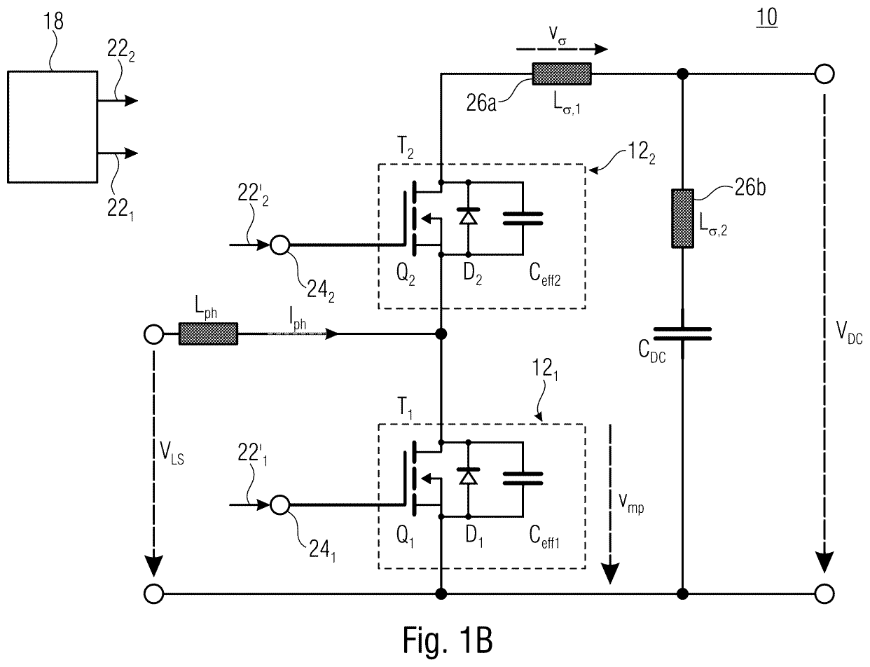

FIG. 1a shows a schematic block circuit diagram of a known apparatus 10. The apparatus 10 includes a switch arrangement 12 with at least one semiconductor switch 12₁. FIG. 1a shows an exemplary half-bridge topology of a DC voltage converter, wherein two semiconductor switches 12₁ and 12₂ are arranged, solely for illustration purposes. Exemplarily, they are formed as MOSFET transistors and possibly comprise intrinsic body diodes 14₁ and 14₂, respectively, referred to as D₁ and D₂. However, it is to be noted that a discrete free-wheeling element may be connected or coupled as an alternative to a body diode, both in MOSFET transistors and other implementations. Furthermore, FIG. 1a shows capacitances C_{eff1} and C_{eff2} that are effective for the semiconductor switches 12₁ and 12₂, respectively, and that may include, e.g. parasitic capacitances of the transistors 12₁ and 12₂, respectively, but that are not limited thereto. Thus, e.g. additional capacitances may also be arranged, e.g. by providing discrete components, so as to adapt the effective capacitance.

Even though FIG. 1a shows a half-bridge topology with two semiconductor switches 12₁ und 12₂, other topologies may comprise less than two semiconductor switches, i.e. one semiconductor switch, or may include more than two semiconductor switches, e.g. three, four or more. In principle, the topology may arbitrarily deviate from a half-bridge topology.

In this case, the semiconductor switch 12₁ is configured for cutting off an electric current path of a commutation circuit. The commutation circuit includes a free-wheeling element, such as the diode 14₂, and a capacitance C_{eff2} or 16₂ effective in parallel to the free-wheeling element. The free-wheeling element may be associated with the semiconductor switch 12₂ or may be a discrete component. In a different state of the circuit of FIG. 1a, the roles of the semiconductor switches 12₁ and 12₂ may be swapped and, e.g., the semiconductor switch 12₂ may be switched, leading to a corresponding complimentary change of the above-described mathematical relationship.

A driving unit (or means for driving) 18 of the apparatus is configured to control the semiconductor switch 12₁ and/or the semiconductor switch 12₂. To this end, the driving unit 18 may provide control signals 22₁ and 22₂ that are coupled, directly or indirectly, e.g. by an interconnection of a driver or an amplifier, to control inputs 24₁ and 24₂, respectively, configured to receive a corresponding input signal 22′₁ and 22′₂, respectively, which may be based on or may correspond to the driving signals 22₁ and 22₂, respectively.

For the switching process, the driving unit 18 may be configured to switch the semiconductor switch 12₁ with a channel cut-off duration that is shorter than a period duration of a resonant oscillation of the commutation circuit.

This makes it possible to excite an oscillation in the commutation circuit. The driving unit 18 is configured for an operating state in which the switching process of the switch 12₁ is carried out based on a cut-off current to be cut off. In case of the known drive, the following is fulfilled for the cut-off current within a tolerance range:

$${I}_{TO , n} = \frac{{V}_{D C} \sqrt{\frac{{( {C}_{eff 1} + {C}_{eff 2} )}^{3}}{{C}_{eff 1} {C}_{eff 2} {L}_{p}}}}{n π}$$

In this case, I_{TO,n} describes the cut-off current to be cut off by the semiconductor switch 12₁, V_{DC} describes the intermediate circuit voltage of the commutation circuit, C_{eff1} describes an effective, i.e. interconnected and/or parasitic, capacitance of the commutation resonant circuit that is associated with the semiconductor switch 12₁, C_{eff2} describes an effective capacitance of the commutation resonant circuit that is associated with the free-wheeling element, and Lₚ, such as Lph, describes an effective electric inductance of the commutation resonant circuit. n describes a natural number in the space of n=2i+1 with i∈ [symbol] ₀.

FIG. 1b shows a further schematic block circuit diagram of the apparatus 10, wherein a parasitic inductance 26, referred to as L_{σ} in FIG. 1a, is divided into a parasitic inductance 26a, referred to as L_{σ,1} and as inductance of the commutation loop, as well as a parasitic inductance of the intermediate circuit 26b, referred to as L_{σ,2}. Initially, this does not change the actual implementation of the circuit, but serves to better understand the present invention.

In other words, FIG. 1a shows the original structure as shown in EP 3 512 085 A1 and DE 10 2022 210 134 A1, while in FIG. 1b the parasitic inductance is split into the parasitic inductance of the commutation loop L_{σ,1} and the parasitic inductance of the intermediate circuit L_{σ,2}.

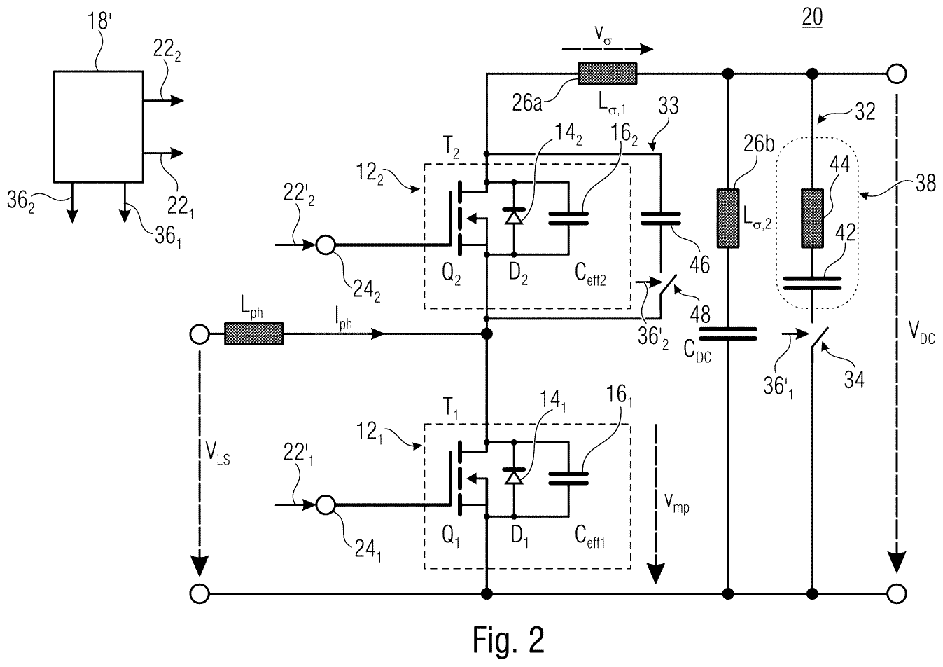

FIG. 2 shows a schematic block circuit diagram of an apparatus 20 according to an embodiment. In parts, the same may be formed in correspondence with apparatus 10 or may enhance/extend the same. Thus, the switch arrangement is provided with at least one of the switching elements 12₁ or 12₂, particularly implemented as a semiconductor switch, such as a MOSFET. While additional switching elements may be provided, the switching element 12₁ or 12₂ may also be implemented as a passively effective switch, such as a diode or the like.

The switching elements 12₁ and 12₂ are configured for cutting off an electric current path of a commutation circuit, wherein the commutation circuit comprises free-wheeling elements 14₁ and/or 14₂ with a capacitance C_{eff1}/16₁ and C_{eff2}/16₂ respectively, effective in parallel.

The apparatus 20 comprises a switchable circuit path 32, 33 to further adapt the cut-off current, compared to the apparatus 10, by causing or carrying out a different influence on the commutation circuit depending on a switching state. Thus, a switchable circuit path 32 comprising a path switching element 34, exemplarily but not necessarily a transistor such as a MOSFET or other types of switches, including a mechanical switch, may be provided.

The path switching element 34 is configured to switch the switchable circuit path 32 between an active or conductive state and an inactive or non-conductive state. Reacting to a driving signal 36′₁, the path switching element 34 may switch between the conductive and the non-conductive state, wherein a corresponding control/drive is based on a driving signal 36₁ of a driving unit 18′. In other words, the driving unit 18′ is configured to control the path switching element, at least in an implementation in which the switchable circuit path 32 is provided.

The switchable circuit path 32 further comprises an electric capacitance element 38 coupled in series with the path switching element 34. For example, the same includes a ceramic capacitor, a foil capacitor element, or the like. In addition to an electric capacitance value 42, a real capacitance element always provides a parasitic inductance 44 as well. At this point, it is to be noted that real components, and therefore also the capacitance element, actually also comprise a parasitic resistance R, here the so-called equivalent series resistance, ESR. In the context of the embodiments, the same is neglected, since it ideally should be 0 ohm or should have a very low ohmic value.

Even though embodiments are not limited to the exclusive use of a parasitic inductance 44, such a capacitance value is usually sufficient for the adaption of the commutation circuit described herein. In alternative implementations, a dedicated inductance element may additionally be provided.

In the above-mentioned conductive or active state, the capacitor element 38, connected in parallel to the circuit path, may adapt, by means of the parasitic inductance 44, an effective inductance of an intermediate circuit associated with the commutation circuit, i.e. the parasitic inductance of the intermediate circuit 26b. In the active state of the switchable circuit path 32, the two inductances 26b and 44 may be considered to be connected in parallel so that the effective inductance decreases due to the parallel connection. The corresponding influence is later described mathematically in detail.

A further implementation of the present invention relates to coupling a switchable circuit path 33. The switchable circuit path 33 includes an electric capacitance element 46 that may be formed in accordance with the electric capacitance element 38 or the same may differ. A switching element 48 that may be formed in accordance with the path switching element 34 and that may be controlled with respect to a conductive or non-conductive state in response to a driving signal 36′₂, which may be based on a driving signal 36₂ of the driving unit 18′, is coupled in series thereto.

In contrast to the switchable circuit path 32, the switchable circuit path 33 is coupled in parallel to the switching element 12₂ and/or alternatively to the switching element 12₁. Same as the switchable circuit path 32, the switchable circuit path 33 is therefore formed in an electric capacitance element 46 configured to, depending on a switching state of the switchable circuit path 33, cause a different influence on the communication circuit.

In the context of the embodiments described herein, the switchable circuit path 32 or the switchable circuit path 33 (parallel to the switching element 12₂ or 12₁) may be implemented.

This does not exclude implementations as combinations, wherein, e.g., the switchable circuit path 32 and the switchable circuit path 33 is provided (in parallel to the switching element 12₂ or to the switching element 12₁. It is also possible to provide a further switchable circuit path in parallel to the switching element 12₁ and additionally to the illustrated switchable circuit path 33. It is also possible to provide additional switchable circuit paths, each being parallel to the switchable circuit paths 32 and/or 33, to cause an increased granularity of the possibilities.

The driving unit 18′ is configured, in a first operating state, to switch the switchable circuit path 32/33 into a first switching state and to switch the path switching element 34/48. Furthermore, the driving unit is configured to control the switching elements 12₁/12₂ for cutting off and for performing a switching process, wherein, in the first switching state, the switching process is carried out on the basis of a first cut-off current, with a first current value, to be cut off. The driving unit is further configured, in a second operating state, to switch the switchable circuit path 32/33 into a second switching state and to control the switching element 12₁/12₂ for cutting off and for carrying out the switching process, wherein, in the second switching state, the switching process is performed on the basis of a second cut-off current, with a second current value, to be cut off.

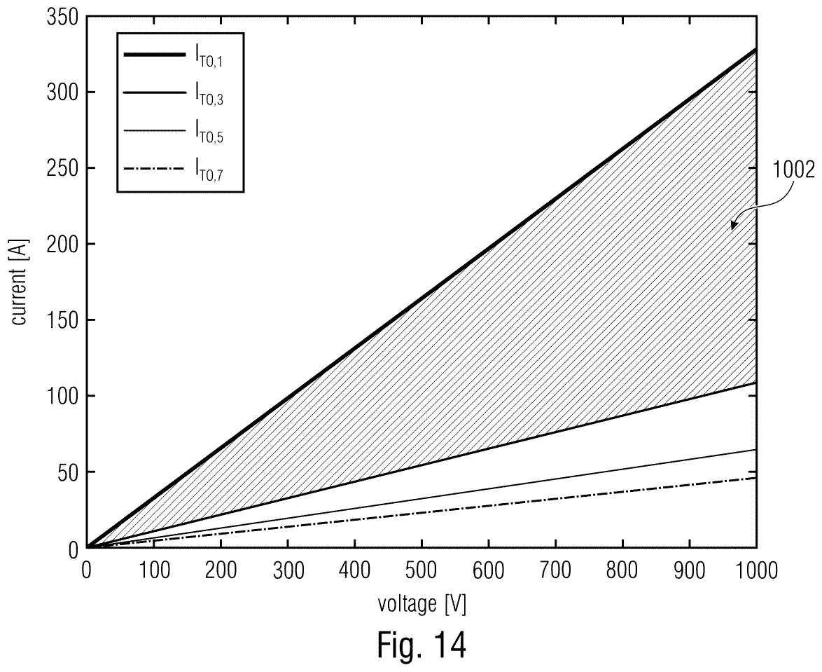

In other words, by the different states of the path switching elements 34/48 that are set by the driving unit 18′, a different property of the effective capacitance values and/or inductance values may be obtained, which is why the characteristic curves known in connection with FIG. 14 may be extended according to the invention.

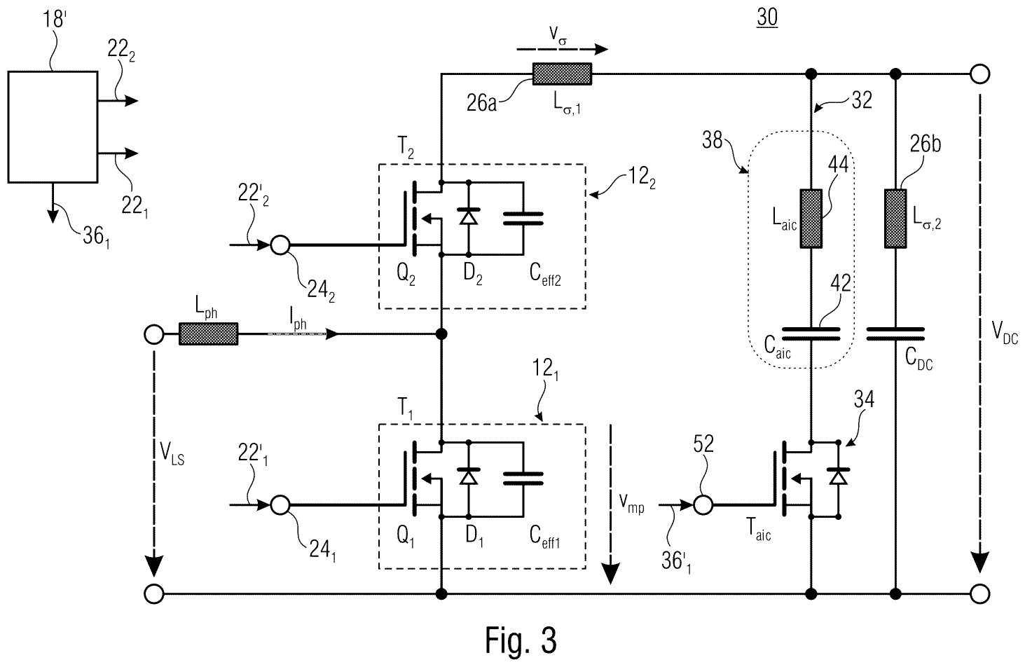

FIG. 3 shows a schematic block circuit diagram of an apparatus 30 according to an embodiment, comprising, on the basis of the apparatus 20, the switchable circuit path 32. The path switching element 34 may be configured as a MOSFET transistor whose gate terminal may be equipped for receiving the driving signal 36′₁. According to embodiments, the switching elements 12₁ and/or 12₂ and a switch of the switchable circuit path 32 and 33, respectively, may include a n-MOSFET, a semiconductor switch with insulated gate electrode, IGBT, or a GaN-based transistor with high electron mobility, GaN-HEMT, wherein switches formed in any other way, preferably but not necessarily semiconductor switches, are not excluded.

The effective intermediate circuit capacitance may be adapted by means of the parasitic inductance 44. Such a concept may be referred to as an active parasitic inductance control (APIC). In APIC, the parasitic inductance 26 in FIG. 1a or 26b in FIGS. 1b, 2 and 3 is actively varied by adding a circuit, the switchable circuit path 32. For example, the additional circuit includes a transistor T_{aic} as a path switching element 34 and a capacitor C_{aic} connected in series as an electric capacitance element 38. The parasitic inductance 44, referred to as L_{aic}, is shown here as well.

In other words, FIG. 3 shows an inventive structure with an additional APIC circuit. According to an embodiment in connection with APIC, the capacitor element is connected in parallel to the circuit path and is configured to adapt, based on the possibly parasitic inductance 44 of the capacitance element 38, an effective inductance of an intermediate circuit associated with the commutation circuit. According to an embodiment, the inductance value 44 of the capacitance element 38 is lower than 50 nH or 30 nH. A minimum value for L_{aic} is not required. The implementation could include all values. For example, L_{σ1}=L_{σ2}=10 nH may be selected and L_{aic}=20 nH may be selected, resulting in L_{σ}=16.67 nH in the context of the example. This makes it possible to effectively and freely adapt L_{σ}. This results in the fact that a larger inductance value may be desired for some applications.

In a preferred embodiment, the switchable circuit path 32 includes the path circuit element 34 for switching the switchable circuit path 32, and the capacitance element 38 is formed as a ceramic capacitor or includes the same and is configured to provide an electric inductance value 44 and an electric capacitance value 42.

According to a preferred embodiment, the driving unit 18′ is configured for an operating state in which the switching process of the switching elements 12₁/12₂ is carried on the basis of a cut-off current to be cut off, if the following is fulfilled in an idealized manner and within a tolerance range

$${I}_{TO , n} = \{ \begin{matrix}\frac{{V}_{D C} \sqrt{\frac{{( {C}_{eff 1} + {C}_{eff 2} )}^{3}}{{C}_{eff 1} {C}_{eff 2} {L}_{σ}}}}{n π} & {T}_{aic} = 0 \\ \frac{{V}_{D C} \sqrt{\frac{{( {C}_{eff 1} + {C}_{eff 2} )}^{3}}{{C}_{eff 1} {C}_{eff 2} ( {L}_{σ , 1} + \frac{{L}_{a ic} {L}_{σ , 2}}{{L}_{a ic} + {L}_{σ , 2}} )}}}{n π} & {T}_{aic} = 1\end{matrix}$$

wherein I_{TO,n} describes the cut-off current to be cut off through the switching element, V_{DC} describes an intermediate circuit voltage of the commutation circuit, C_{eff1} describes an effective capacitance, associated with the switching element, of the commutation resonant circuit, C_{eff2} describes an effective capacitance, associated with the free-wheeling element, of the commutation resonant circuit, L_{σ} describes in correspondence with the above parameter L_{P} an effective electric inductance of the commutation resonant circuit, which may be broken down into L_{σ1} as a parasitic inductance of the commutation circuit and in L_{σ2} as a parasitic inductance of an intermediate circuit associated with the commutation circuit, L_{aic} describes an electric inductance of the switchable circuit path, T_{aic}=0 describes a non-conductive state of the switchable circuit path, T_{aic}=1 describes a conductive state of the switchable circuit path, and n describes a natural number in the space n=2i+1 with i∈ [symbol] ₀.

The upper case of the equation (T_{aic}=0) corresponds to the known driving method of DE 10 2022 210 134 A1. However, in an active or conductive state of the path circuit element 34, the inductance value 44 or L_{aic} becomes effective, shifting the cut-off current correspondingly, which may be used, according to the invention, to provide further operating points of the circuit. Accordingly, the equation now contains a dependency of the switch position T_{aic}.

Embodiments are not limited to the use of only one switchable circuit path 32, additional cut-off paths may also be configured.

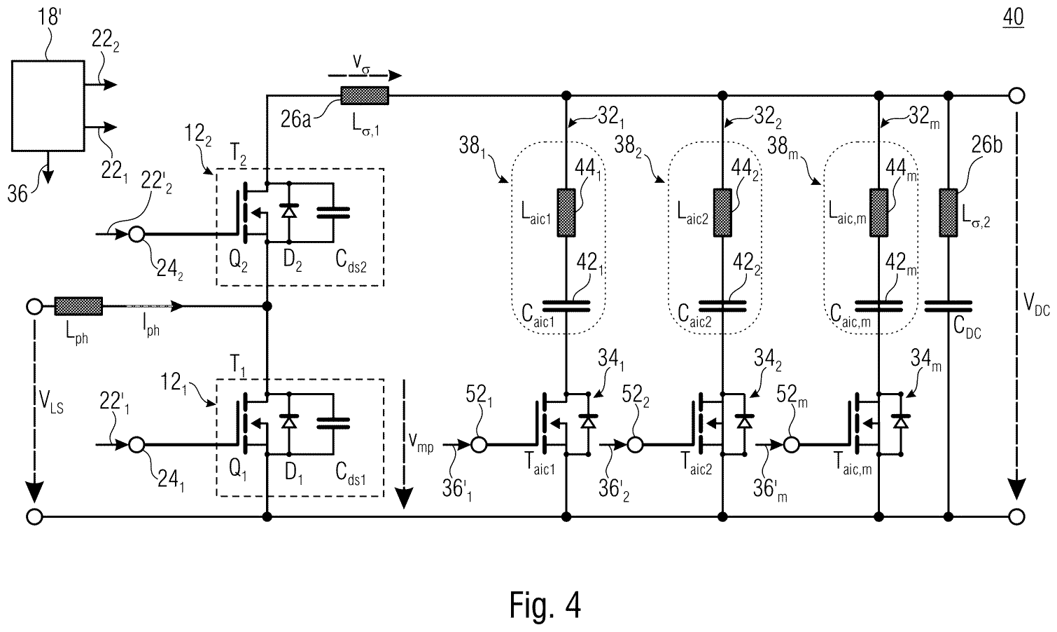

FIG. 4 shows a schematic block circuit diagram of an apparatus 40 according to an embodiment, wherein, in contrast to the apparatus 30 of FIG. 3, a number of m>1 switchable circuit paths is connected in parallel. Exemplarily, but not limiting the embodiments, m=3, and each of the switchable circuit paths 32₁, 32₂ and 32ₘ includes a switching element 34₁, 34₂ or 34ₘ, respectively, wherein control terminals 52₁, 52₂ and 52ₘ, respectively, such as gate terminals, can be driven individually, in groups or for all terminals on the basis of a driving signal 36 of the driving unit 18′. If a common driving signal 36 is used, e.g. to adjust more finely the inductance values 44₁ to 44ₘ, acting on the intermediate circuit inductance 26b, due to the parallel connection achieved, the capacitance elements 38 may also be connected in parallel in a suitable circuit path, i.e. they may be activated or deactivated using a common path switching element 34.

In the implementation shown, the driving unit 18′ is configured, based on an input current or output current of the apparatus and depending on an intermediate circuit voltage, to select the cut-off current and to set the combination of switching states on the basis of the cut-off current. To this end, depending on the desired operating states, none of the switchable circuit paths 32₁ to 32ₘ, a selected one, a group of the same or all of them may be switched to be active.

Such an implementation of the individual activation/deactivation of switchable circuit paths is also possible in an alternative or additional implementation, wherein one or several circuit paths 33 of FIG. 1 are implemented. In the respective configuration, the switchable circuit path may be one of a plurality of switchable circuit paths coupled in parallel, wherein the driving unit 18′ may be configured to individually drive each of the plurality of switchable circuit paths. Each of the combination of switching states of the plurality of switchable circuit paths may be associated with a current/voltage characteristic curve of the apparatus with respect to a cut-off current flowing through the switching element when carrying out the switching, and may optionally be associated with a voltage level to be adjusted using the switching process.

To this end, the driving unit may be coupled to a data storage element, e.g. as part of the driving unit 18′ or as an external component. The same may store information associated with an output current to be provided by the apparatus or an output voltage to be provided by the apparatus on the one hand and the combination of switching states on the other hand. The driving unit 18′ may be configured, on the basis of a measured current, e.g. in the switching element 12₁ and/or 12₂ to be switched, or a pre-specified value thereof, to read the combination of switching states from the data storage element and to set (or adjust) the same.

The embodiments of FIGS. 3 and 4 illustrate examples of an APIC circuit that is used to try to vary the parasitic inductance of the intermediate circuit 26b. This is achieved by changing the parasitic inductance 26b by switchable low-impedance capacitors 38₁ to 38ₘ.

The APIC circuit can be implemented with a single, or even a higher number of, represented by M, branch or path connected in parallel, as is illustrated in FIG. 4. This makes it possible to compute/calculate the changed parasitic inductance according to the law of parallel connections of inductances as follows:

$$\frac{1}{{L}_{aic}} = {\sum }_{m = 1}^{M} \frac{1}{{L}_{aic , m}}$$

The APIC circuit makes it possible to scale the effective inductance L_{σ}. Even though embodiments do not exclude such an implementation, embodiments are usually not directed to implement the parasitic inductance as low as possible as is previously known in the prior art. Now, however, the parasitic inductance is considered to be an actively changeable parameter and is adjusted, which in turn has an influence on the cut-off current I_{TO,n}.

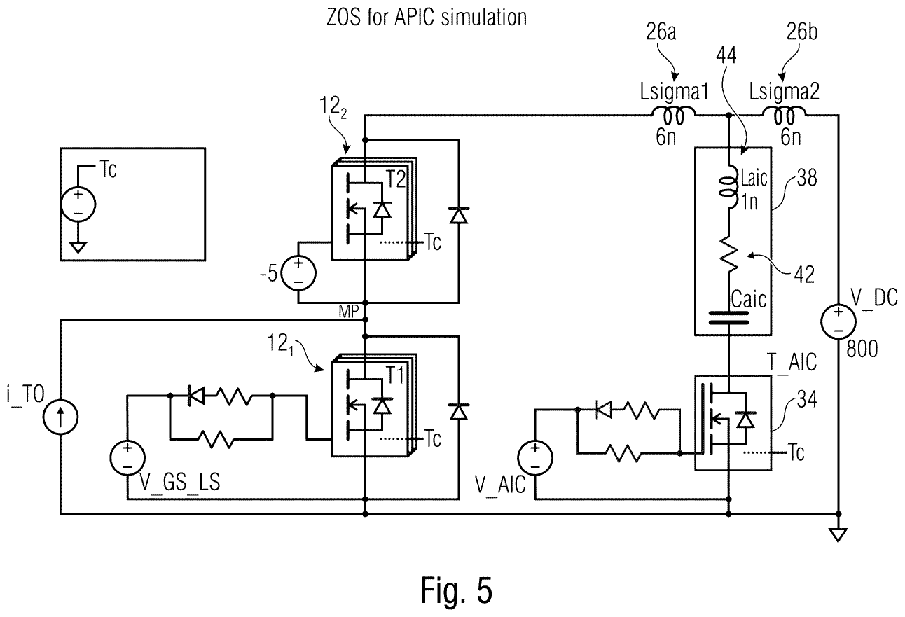

FIG. 5 shows a schematic block circuit diagram of a simulation proof of embodiments described herein and in connection with an APIC circuit.

The functionality of the present invention has been verified through simulation using LT spice. For example, the simulation uses a half-bridge configuration with a parallel connection of 4 SiC-MOSFETs. The SiC-MOSFETs are based on a model of the manufacturer. As a first assumption, the same inductance of 6 nH is selected for the inductances 26a (L_{σ,1}) and 26b (L_{σ,2}).

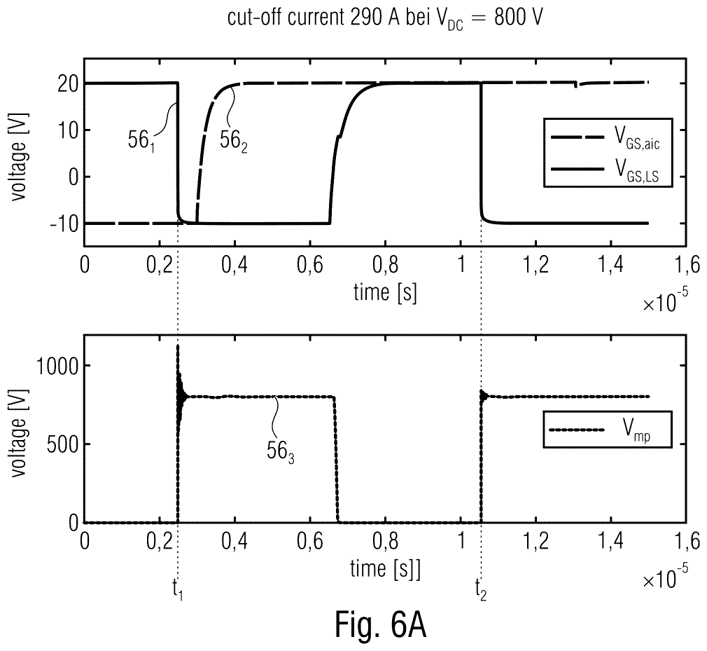

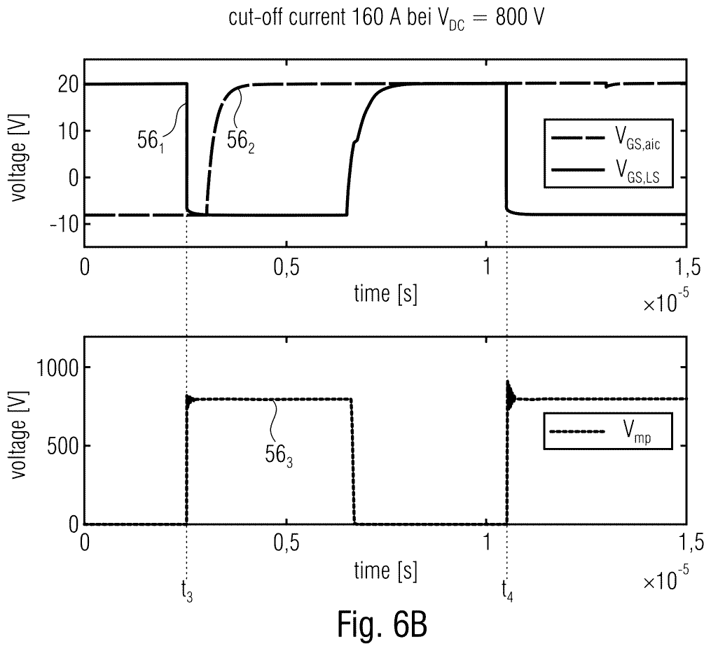

Exemplarily and without limiting effect for the embodiments, FIGS. 6a and 6b each show a gate voltage of the low-side switches T₁ or 12₁ in a curve 56₁ as well as the gate voltage of the MOSFETs T_{aic} in a curve 56₂. It becomes clear that the overvoltage is at a maximum at Vₘₚ in the first cut-off process, illustrated in a curve 56₃, while the same is at a minimum in the second cut-off process. The first cut-off process is denoted with t₁ and the second cut-off process is denoted with t₂, curves 56₁ to 56₃ are illustrated on a corresponding time axis. The difference in curve 56₃ between the cut-off times t₁ and t₂ is that T_{aic} is activated in the second cut-off time t₂ and that the operating point of the circuit has therefore been shifted, i.e. towards the correctly set time. The cut-off current was selected with a value of 290 A.

The same relationship can be found in case of a cut-off current of 160 A, which forms the basis of FIG. 6b. The cut-off currents of FIGS. 6a and 6b each are I_{TO,1} but in case of different switch positions of T_{aic}. In FIG. 6b, at time t₃, the cut-off process is carried out in case of a correctly adjusted circuit, and at time t₄, the circuit is detuned by means of the position of the path switching elements 34 such that significant overvoltages can again be seen in the curve 56₃.

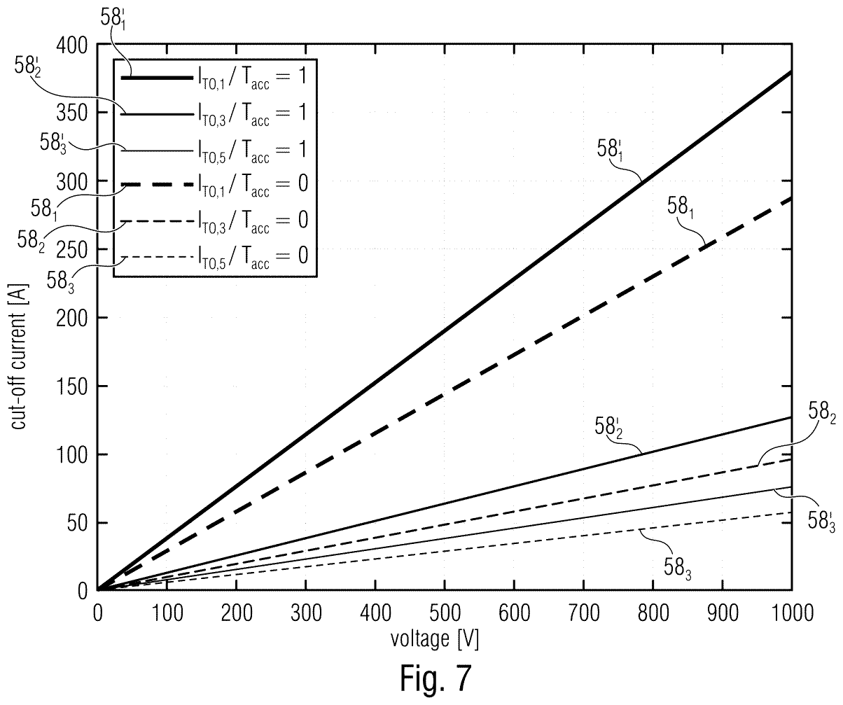

FIG. 7 shows an illustration, derived from FIG. 14, to highlight the inventive advantages using the APIC circuit, i.e. the possibility to adjust the effective inductance. The curves 58₁, 58₂ and 58₃ are illustrated in a linear way, for simplicity reasons, corresponding to the curves 58₁ to 58₃ of FIG. 14, even though the curves refer to different circuits, which can be seen in the different amplitudes. For these curves referring to I_{TO,1}, I_{TO,3} and I_{TO,5}, the path switching element 34 of the apparatus 30 is switched so as to be non-conductive, and for curves 58′₁, 58′₂ and 58′₃ derived therefrom, it is switched so as to be conductive for the same cut-off currents, which is why the effective inductance is changed, e.g. decreased, and the cut-off current with which switch off is possible with a low overvoltage is accordingly increased. For example, it is shown that a cut-off current, which is an addition compared to FIG. 14, is created between the curves 58₁ and 58₂.

In other words, FIG. 7 illustrates the relationship of the different operating ranges depending on the switch position T_{aic}. It is based on linear values and cannot be compared directly to the result of the simulation. The parasitic inductances of L_{σ,1} and L_{σ,2}(26a, 26b) are at 6 nH and L_{aic} and 1 nH. The effective capacitances C_{eff1} and C_{eff2} are at a total of 1.2 nF.

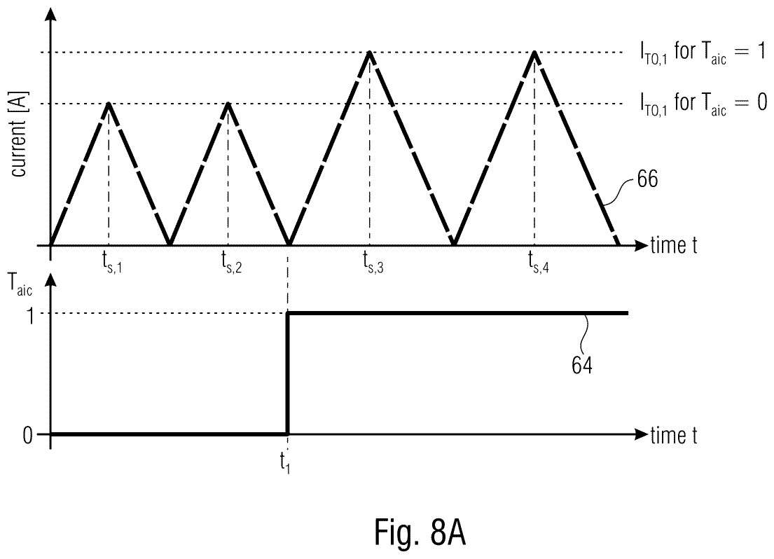

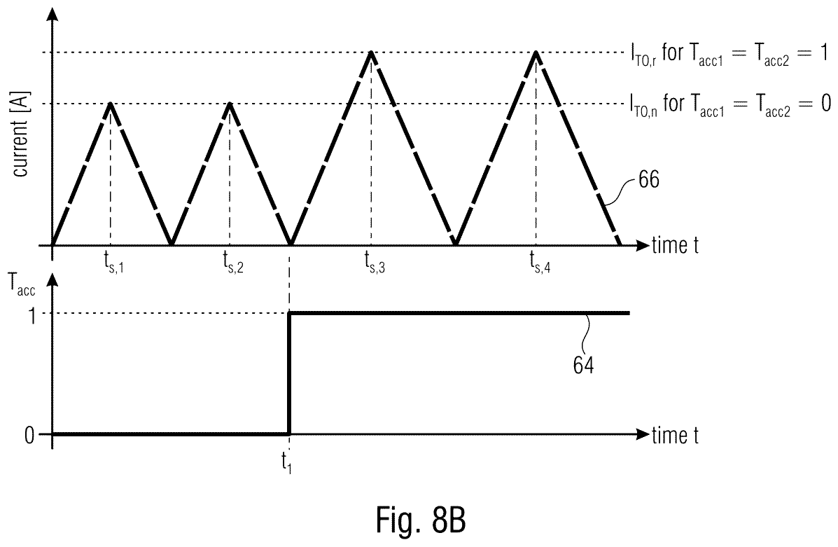

FIG. 8a shows a schematic qualitative diagram of an effect of switching the path switching element according to the APIC concept and exemplarily for a cut-off current I_{TO,1}, wherein the results can readily be transferred to other cut-off currents, such as I_{TO,3}, I_{TO,5} or the like. At a time t₁, the state of the path switching element is switched so as to be conductive, T_{aic}=1. Through this, in correspondence with the disclosure provided herein, the cut-off current determining the cut-off times t_{s,1} to t_{s,4} can be increased. Illustrated by curve 64, the path switching element may be controlled in a quasi-static way so that several, in particular many, switching cycles, e.g. some 100 cycles or some 1000 cycles, preferably more, of the cut-off current are carried out in an unchanged state of the path switching element, as indicated by curve 66.

FIG. 8b shows a schematic qualitative diagram of an effect of switching the path switching element according to the ACC concept and exemplarily for a cut-off current I_{TO,1}, wherein the results can readily be transferred to other cut-off currents, such as I_{TO,3}, I_{TO,5} or the like. At time t₁, the state of the path switching element is switched so as to be conductive, T_{acc}=1.

Through this, in correspondence with the disclosure provided herein, the cut-off current that determines cut-off times t_{s,1} to t_{s,4} may be increased. Illustrated by curve 64, the path switching element may be controlled in a quasi-static way so that several, in particular many, switching cycles, e.g. some 100 or some 1000, of the cut-off current may be carried out in an unchanged state of the path switching element, as is indicated by curve 66.

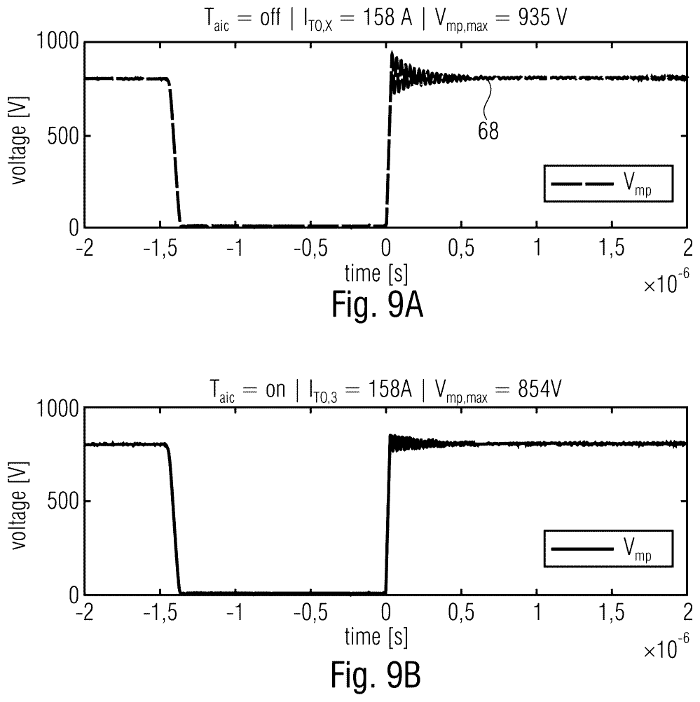

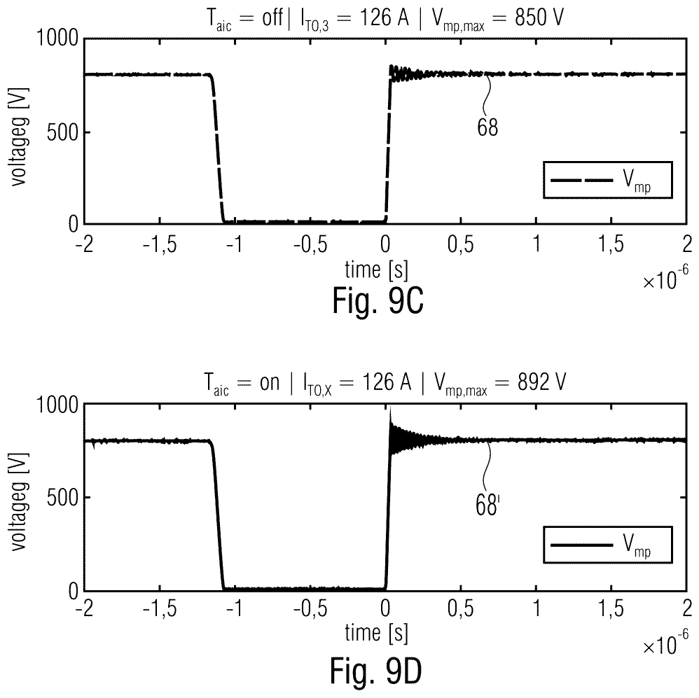

In FIGS. 9a-b, exemplarily and without limiting effect in connection with embodiments, measurement results are illustrated based on an exemplary cut-off current I_{TO,3}. First, FIG. 9a shows results of a measurement with a switched-off transistor T_{aic}, e.g. an apparatus according to FIG. 3, and for a cut-off current I_{TO,X} of 158 A, which is also the basis of the drive. FIG. 9b shows associated results with a same cut-off current, but an active circuit path on the basis of switching on (T_{aic}=on), with a cut-off current I_{TO,3} that fits the circuit. In FIG. 9a, the same cut-off current of 158 A does not fit the circuit with respect to ZOS, but fits the circuit in FIG. 9b, which can be seen at overvoltage peaks of 135 V in FIG. 9a and 54 V in FIG. 9b, respectively, with respect to 800 V V_{DC}. These values are selected arbitrarily and may vary depending on the implementation of an actual circuit.

In FIGS. 9a and 9b, the same cut-off current is driven, however, once with a transistor T_{aic} (T_{aic}=off) that is switched off and once with a transistor T_{aic} (T_{aic}=on) that is switched on. Due to detuning in FIG. 9 and with respect to the same cut-off current of 158 A, an effectively higher overvoltage of a curve 68 representing the voltage can be seen, if a maximum amplitude of 935 V is compared to a maximum amplitude of 854 V of the curve 68′ of FIG. 9b. This is based on the detuning of the circuit by the path switching element 34.

In a further exemplary measurement sequence, the ZOS cut-off current I_{TO,3} is implemented for an inactive circuit path and is exemplarily shown in FIG. 9c for a T_{aic} that is switched off. It can be seen that the cut-off current I_{TO,3} is at 126 A, and that cutting off this current leads to a low switching overvoltage. Due to the effectiveness of the ZOS in FIG. 9c by adapting the circuit and the cut-off current, the same is referred to as I_{TO,3}. Detuning the circuit on the basis of switching on or activating the path (T_{aic}=on) leads to the fact that the same cut-off current of 126 A is referred to as I_{TO,X}. This exemplarily results in a maximum voltage of 850 V for V_{DC} of 800 V in FIG. 9c and a degraded voltage of 892 V in FIG. 9d.

This results in the fact that both of the states T_{aic}, conductive and non-conductive, may be used as a respective reference state so as to detune the circuit by switching the path switching element 34 or by a different configuration of several paths overall.

This shows that different operating ranges can be set by switching on and cutting off T_{aic}.

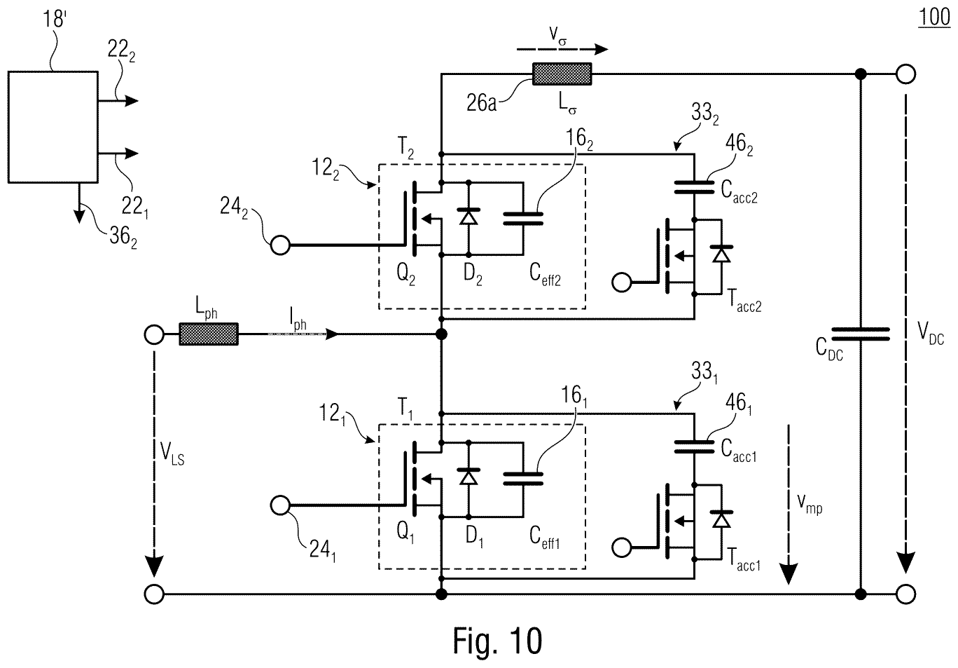

FIG. 10 shows a schematic block circuit diagram of an apparatus 100 according to an embodiment, wherein the capacitance elements 46₁ and 46₂ are connected in parallel to the semiconductor switches 12₁ and 12₂ so as to adjust an effective capacitance C_{eff1}, or 16₁, and C_{eff2}, or 16₂, of the switching element. Even though capacitance elements 46₁ and 46₂ are connected in parallel to both semiconductor switches 12₁ and 12₂ in FIG. 10, according to embodiments, there may be an asymmetric influence by a parallel connection to only one of the two semiconductor switches 12₁ and 12₂. Each of the two switchable paths is switchable by a means of the path switching elements T_{acc1} and T_{acc2}. According to embodiments, in case of a symmetric and/or asymmetric influence, several switching paths 33 are connected in parallel to each other and in parallel to the semiconductor switch 12₁ and 12₂, as is similarly described for the parallel connection of several inductive paths 32.

While the parasitic inductance of the commutation circuit may be changed in APIC, a concept, according to the invention and illustrated in FIG. 10, for active capacitance control (ACC) enables changing the effective capacitance C_{eff1} and the effective capacitance C_{eff2}. To this end, exemplarily, the equation of DE 10 2022 210 134 A1 is extended as follows:

$${I}_{TO , n} = \{ \begin{matrix}\frac{{V}_{D C} \sqrt{\frac{{( {C}_{eff 1} + {C}_{eff 2} )}^{3}}{{C}_{eff 1} {C}_{eff 2} {L}_{σ}}}}{n π} & {T}_{acc} = 0 \\ \frac{{V}_{D C} \sqrt{\frac{{( {C}_{eff 1} + {C}_{acc 1} + {C}_{eff 2} + {C}_{acc 2} )}^{3}}{( {C}_{eff 1} + {C}_{acc 1} ) ( {C}_{eff 2} + {C}_{acc 2} ) {L}_{σ}}}}{n π} & {T}_{acc} = 1\end{matrix}$$

The driving unit 18′ may be configured for a corresponding operating state in which the switching process is carried out on the basis of the described cut-off current, wherein the above condition is ideally fulfilled at least within a tolerance range of ±10%, ±5%, preferably less, approximately 2%. In this case, I_{TO,n} describes the cut-off current, to be cut off, through the switching element (12₁, 12₂), V_{DC} describes an intermediate circuit voltage of the commutation circuit, C_{eff1} describes an effective capacitance, associated with the switching element (12₁, 12₂), of the commutation resonant circuit, C_{eff2} describes an effective capacitance, associated with the free-wheeling element (14₁, 14₂), of the commutation resonant circuit, L_{σ} describes an effective electric inductance of the commutation resonant circuit, C_{acc1} describes an electric capacitance, effective in parallel to C_{eff1}, of the switchable circuit path, C_{acc2} describes an electric capacitance, effective in parallel to C_{eff2}, of the switchable circuit path, T_{acc}=0 describes a non-conductive state of the switchable circuit path, T_{acc}=1 describes a conductive state of the switchable circuit path, and n describes a natural number in the space n=2i+1 with i being ∈ [symbol] ₀.

The equation indicated above can be applied to an embodiment in which the switches T_{acc1} and T_{acc2} are driven equally, e.g. synchronously. For an individual drive of the two switches T_{acc1} and T_{acc2}, the following may apply:

$${I}_{TO , n} = \{ \begin{matrix}\frac{{V}_{D C} \sqrt{\frac{{( {C}_{eff 1} + {C}_{eff 2} )}^{3}}{{C}_{eff 1} {C}_{eff 2} {L}_{σ}}}}{n π} & {T}_{acc 1} = 0 ∧ {T}_{acc 2} = 0 \\ \frac{{V}_{D C} \sqrt{\frac{{( {C}_{eff 1} + {C}_{acc 1} + {C}_{eff 2} )}^{3}}{( {C}_{eff 1} + {C}_{acc 1} ) {C}_{eff 2} {L}_{σ}}}}{n π} & {T}_{acc 1} = 1 ∧ {T}_{acc 2} = 0 \\ \frac{{V}_{D C} \sqrt{\frac{{( {C}_{eff 1} + {C}_{eff 2} + {C}_{acc 2} )}^{3}}{{C}_{eff 1} ( {C}_{eff 2} + {C}_{acc 2} ) {L}_{σ}}}}{n π} & {T}_{acc 1} = 0 ∧ {T}_{acc 2} = 1 \\ \frac{{V}_{D C} \sqrt{\frac{{( {C}_{eff 1} + {C}_{acc 1} + {C}_{eff 2} + {C}_{acc 2} )}^{3}}{( {C}_{eff 1} + {C}_{acc 1} ) ( {C}_{eff 2} + {C}_{acc 2} ) {L}_{σ}}}}{n π} & {T}_{acc 1} = 1 ∧ {T}_{acc 2} = 1\end{matrix}$$

It is to be noted that, for the ACC concept and for the APIC concept, an opened path switching element is considered to be a non-implemented path switching element or as not influencing the circuit. The above equation can be changed when implementing only one of the two paths acc1 or acc2 such that the other, non-provided, term is ignored.

Parallel connection of capacitors to the switches T₁ and T₂ to shift the operating range is accordingly also an effective means in the context of embodiments. The principle of connecting and disconnecting capacitors and the influence on the ZOS operating range proposed herein is explicitly shown in the context on the present disclosure for the APIC circuit.

In other words, FIG. 10 shows an implementation of an inventive ACC circuit. Similar to the APIC circuit, an additional circuit consisting of a transistor and a capacitor is used in the ACC. To this end, actively switchable capacitors are connected in parallel to the transistors T₁ and T₂.

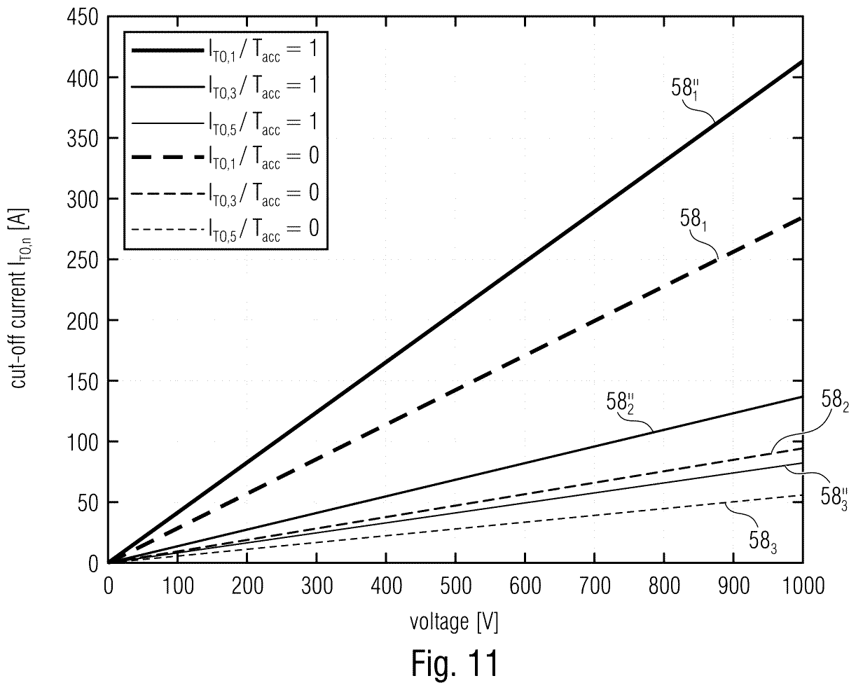

To further illustrate the ACC results, FIG. 11 illustrates a variation of FIG. 7 for the capacitive adaption in the context of the embodiments. Curves 58₁ to 58₃ show curves 58₁ to 58₃ corresponding to those of FIG. 7. Circuit paths 33₁ and 33₂ connected in parallel to the semiconductor switches 12₁ and 12₂ are simultaneously switched and are exemplarily built symmetrically. Influenced curves 58″₁, 58″₂ und 58″₃ differ from the curves 58′₁, 58′₂ und 58′₃ of FIG. 7. In other words, FIG. 11 shows a visualization of different ZOS operating points across V_{DC} with ACC.

ACC and APIC may be implemented and operated together in the context of embodiments. Such an embodiment provides an apparatus in which the switchable circuit path is a first switchable circuit path and in which the capacitor element is connected in parallel to the circuit path and an electric inductance of the capacitance element is available so as to adapt an effective inductance of an intermediate circuit associated with the commutation circuit, as is exemplarily described in connection with FIGS. 2 and 3.

Furthermore, at least one second switchable circuit path including a second capacitance element connected in parallel to the switching element is provided so as to adapt an effective capacitance of the switching element. One or several of these circuit paths may be extended by additional circuit paths that are connected in parallel.

A driving unit according to such an embodiment may be configured to set an operating state in which the switching process is carried out on the basis of the cut-off current to be cut off, if the following is fulfilled, ideally within a tolerance range of ±10%, ±5%, preferably less, approximately ±2%:

$${I}_{TO , n} = \{ \begin{matrix}\frac{{V}_{D C} \sqrt{\frac{{( {C}_{eff 1} + {C}_{eff 2} )}^{3}}{{C}_{eff 1} {C}_{eff 2} {L}_{σ}}}}{n π} & {T}_{acc} = 0 ∧ {T}_{aic} = 0 \\ \frac{{V}_{D C} \sqrt{\frac{{( {C}_{eff 1} + {C}_{acc 1} + {C}_{eff 2} + {C}_{acc 2} )}^{3}}{( {C}_{eff 1} + {C}_{acc 1} ) ( {C}_{eff 2} + {C}_{acc 2} ) {L}_{σ}}}}{n π} & {T}_{acc} = 1 ∧ {T}_{aic} = 0 \\ \frac{{V}_{D C} \sqrt{\frac{{( {C}_{eff 1} + {C}_{eff 2} )}^{3}}{{C}_{eff 1} {C}_{eff 2} ( {L}_{σ , 1} + \frac{{L}_{aic} {L}_{σ , 2}}{{L}_{aic} + {L}_{σ , 2}} )}}}{n π} & {T}_{acc} = 0 ∧ {T}_{aic} = 1 \\ \frac{{V}_{D C} \sqrt{\frac{{( {C}_{eff 1} + {C}_{acc 1} + {C}_{eff 2} + {C}_{acc 2} )}^{3}}{( {C}_{eff 1} + {C}_{acc 1} ) ( {C}_{eff 2} + {C}_{acc 2} ) ( {L}_{σ , 1} + \frac{{L}_{aic} {L}_{σ , 2}}{{L}_{aic} + {L}_{σ , 2}} )}}}{n π} & {T}_{acc} = 1 ∧ {T}_{aic} = 1\end{matrix}$$

wherein I_{TO,n} is the cut-off current, to be cut off, through the switching element, V_{DC} is an intermediate circuit voltage of the commutation circuit, C_{eff1} is an effective capacitance, associated with the switching element, of the commutation resonant circuit, C_{eff2} is an effective capacitance, associated with the free-wheeling element, of the commutation resonant circuit,
L_{σ1} is a parasitic inductance of the commutation circuit, L_{σ2} is a parasitic inductance of an intermediate circuit associated with the commutation circuit, L_{aic} is an electric inductance of the first switchable circuit path, C_{acc1} is an electric capacitance, effective in parallel to C_{eff1}, of the switchable circuit path, C_{acc2} is an electric capacitance, effective in parallel to C_{eff2}, of the switchable circuit path and n is a natural number in the space n=2i+1, with i∈ [symbol] ₀;
wherein T_{aic}=0 designates a non-conductive state of the first switchable circuit path, T_{aic}=1 designates a conductive state of the first switchable circuit path; T_{acc}=0 designates a non-conductive state of the second switchable circuit path, T_{acc}=1 designates a conductive state of the second switchable circuit path.

The equation assumes that T_{acc} means the same as T_{acc1} and T_{acc2}, i. e. both switches are driven. Variations exist for the case that only one switch is to be driven.

In general, the previous equation may be illustrated in a more general form and for the case of the individual control of the switches T_{acc1} and T_{acc2} as follows:

$${I}_{TO , n} = \{ \begin{matrix}\frac{{V}_{D C} \sqrt{\frac{{( {C}_{eff 1} + {C}_{eff 2} )}^{3}}{{C}_{eff 1} {C}_{eff 2} {L}_{σ}}}}{n π} & {T}_{acc 1} = 0 ∧ {T}_{acc 2} = 0 ∧ {T}_{aic} = 0 \\ \frac{{V}_{D C} \sqrt{\frac{{( {C}_{eff 1} + {C}_{eff 2} )}^{3}}{{C}_{eff 1} {C}_{eff 2} ( {L}_{σ , 1} + \frac{{L}_{aic} {L}_{σ , 2}}{{L}_{aic} + {L}_{σ , 2}} )}}}{n π} & {T}_{acc 1} = 0 ∧ {T}_{acc 2} = 0 ∧ {T}_{aic} = 1 \\ \frac{{V}_{D C} \sqrt{\frac{{( {C}_{eff 1} + {C}_{eff 2} + {C}_{acc 2} )}^{3}}{{C}_{eff 1} ( {C}_{eff 2} + {C}_{acc 2} ) {L}_{σ}}}}{n π} & {T}_{acc 1} = 0 ∧ {T}_{acc 2} = 1 ∧ {T}_{aic} = 0 \\ \frac{{V}_{D C} \sqrt{\frac{{( {C}_{eff 1} + {C}_{eff 2} + {C}_{acc 2} )}^{3}}{{C}_{eff 1} ( {C}_{eff 2} + {C}_{acc 2} ) ( {L}_{σ , 1} + \frac{{L}_{aic} {L}_{σ , 2}}{{L}_{aic} + {L}_{σ , 2}} )}}}{n π} & {T}_{acc 1} = 0 ∧ {T}_{acc 2} = 1 ∧ {T}_{aic} = 1 \\ \frac{{V}_{D C} \sqrt{\frac{{( {C}_{eff 1} + {C}_{acc 1} + {C}_{eff 2} )}^{3}}{( {C}_{eff 1} + {C}_{acc 1} ) {C}_{eff 2} {L}_{σ}}}}{n π} & {T}_{acc 1} = 1 ∧ {T}_{acc 2} = 0 ∧ {T}_{aic} = 0 \\ \frac{{V}_{D C} \sqrt{\frac{{( {C}_{eff 1} + {C}_{acc 1} + {C}_{eff 2} )}^{3}}{( {C}_{eff 1} + {C}_{acc 1} ) {C}_{eff 2} ( {L}_{σ , 1} + \frac{{L}_{aic} {L}_{σ , 2}}{{L}_{aic} + {L}_{σ , 2}} )}}}{n π} & {T}_{acc 1} = 1 ∧ {T}_{acc 2} = 0 ∧ {T}_{aic} = 1 \\ \frac{{V}_{D C} \sqrt{\frac{{( {C}_{eff 1} + {C}_{acc 1} + {C}_{eff 2} + {C}_{acc 2} )}^{3}}{( {C}_{eff 1} + {C}_{acc 1} ) ( {C}_{eff 2} + {C}_{acc 2} ) {L}_{σ}}}}{n π} & {T}_{acc 1} = 1 ∧ {T}_{acc 2} = 1 ∧ {T}_{aic} = 0 \\ \frac{{V}_{D C} \sqrt{\frac{{( {C}_{eff 1} + {C}_{acc 1} + {C}_{eff 2} + {C}_{acc 2} )}^{3}}{( {C}_{eff 1} + {C}_{acc 1} ) ( {C}_{eff 2} + {C}_{acc 2} ) ( {L}_{σ , 1} + \frac{{L}_{aic} {L}_{σ , 2}}{{L}_{aic} + {L}_{σ , 2}} )}}}{n π} & {T}_{acc 1} = 1 ∧ {T}_{acc 2} = 1 ∧ {T}_{aic} = 1\end{matrix}$$

In other words, ACC and APIC may also be operated together, resulting in a multitude of degrees of freedom.

It is to be noted that the circuit may have further parasitic components influencing the switching behavior and overvoltages. However, for the idealized consideration illustrated herein, they have very little influence so that they can be neglected without renunciation of the present disclosure.

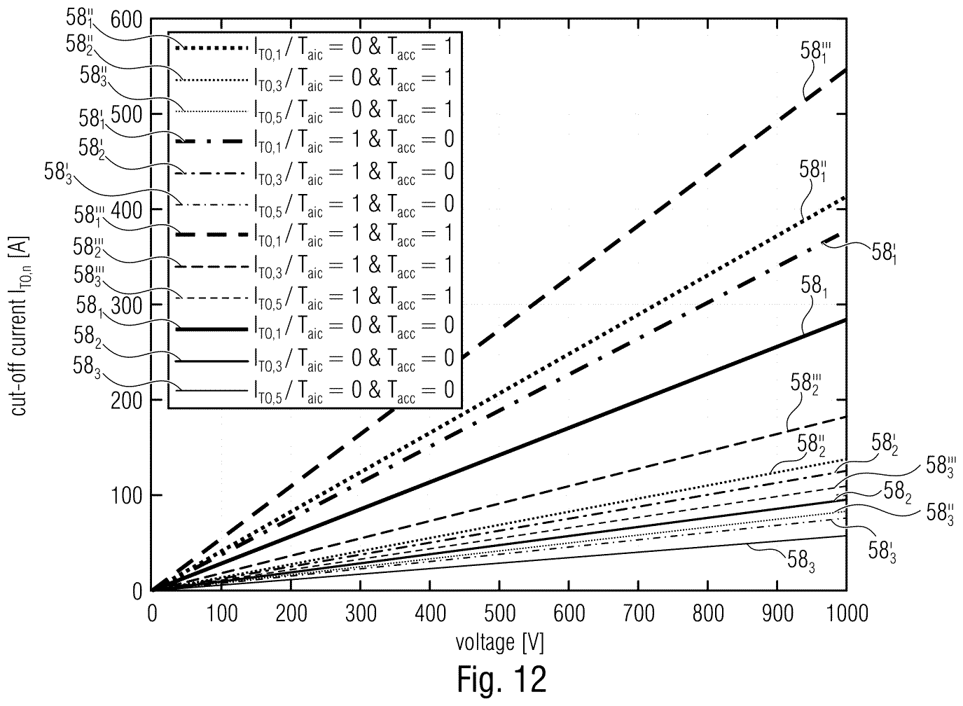

FIG. 12 shows an exemplary schematic illustration for a mutual implementation of ACC and APIC, i.e. switchable circuit paths 32 and 33, to illustrate the increase in number of possible operating points. It can be seen that a multitude of possible operating currents may be set.

In contrast to known implementations, such as EP 3 772 180 A1, the transistor T₁ may be arranged differently in the context of present embodiments. In the APIC concept, i.e. the switchable circuit paths 32, the transistor T₁ may be arranged as a low-side switch. The transistor of such an APIC circuit does not necessarily have to be switched in each switching process of the apparatus. However, APIC may be based on ZOS and may not be based on conventional switching. The parasitic inductance L_{σ} becomes adjustable through the APIC concept and is not necessarily as small as possible, as is implemented in the prior art, to set small overvoltages. By L_{σ} being adjustable, further ZOS operating points or cut-off currents may be set, however, the advantages of ZOS, i.e. low overvoltages at maximum switching speeds, may further be used.

A driving unit of an apparatus according to an embodiment may be configured to switch, on the basis of a voltage level to be set with the switching process and on the basis of a cut-off current to be cut off, flowing through the switching element when carrying out the switching, the switchable circuit path 32/33 into a conductive or non-conductive state as a state to be set. The state to be set may be associated with lower cut-off overvoltages at the switching element, compared to a different state, cf. e.g. FIGS. 9a-d, i.e. the ZOS-suitable cut-off current.

According to embodiments, when using several switchable circuit paths 32, several switchable circuit paths 33, and/or a combination thereof, the driving unit sets a respective state of the sum at all switchable circuit paths, e.g. based on a data storage element or the like.

The driving unit may further be configured, for the switching process, to switch the switching element with a channel cut-off duration that is shorter than a period duration of a resonance oscillation of the commutation circuit, which makes it possible to excite an oscillation in the commutation circuit.

For example, if the corresponding cut-off current is set, e.g. because the driving unit has set or changed a state of the switchable circuit path so as to change an operating state of the apparatus, the apparatus may leave the operating state unchanged and close the switching element several times. In other words, the switchable circuit path 32/33 may be switched or set and the switching elements 12₁ and 12₂ may then be switched without having to again switch the switchable circuit paths.

Using APIC (circuit path 32) and ACC (circuit path 33), it is possible to utilize the advantages of ZOS and eZOSa with additional cut-off currents. With a predetermined intermediate circuit voltage, it is further possible via eZOSa to adjust several discrete current values of a converter system. When using the further cut-off currents, the advantage of ZOS is included, i.e. the operation is possible with a maximum switching speed at a minimum cut-off overvoltage. This increases the total efficiency of the power electronic device. When reducing the losses, it is possible to reduce the size of the required cooling, having a positive influence on weight, volume, and cost.

Furthermore, the use of ACC and/or APIC may reduce the voltage oscillations or keep them low, reducing the filter effort so as to further ensure the conformity with EMV directives. A lower filter effort means that the filter unit may be smaller and/or lighter.

Embodiments may be used in a multitude of hard-switching topologies with ZOS and therefore, also for eZOSa. Using eZOSa and the APIC and/or ACC approaches introduced herein, a further range of applications may become possible, compared to EP 3 512 085 A1. Possible fields of application are DC/DC converters, among other things for fuel cell applications as well as power electronics for photovoltaic and storage systems. Applications in power electronics in electromobility, e.g. in onboard chargers, are also possible.

Compared to the prior art, where the ZOS can only be used in discrete cut-off currents in case of an applied voltage and wherein several cut-off currents may be achieved in the lower current range at a given voltage, while there are no cut-off currents between I_{TO,1} or I_{TO,3} and above I_{TO,1}, embodiments make it possible to further extend the application range of ZOS and eZOSa by allowing to set a multitude of cut-off currents via additional circuits. While eZOSa makes it possible to introduce further cut-off currents below I_{TO,1}, embodiments with respect to ACC and APIC make it possible to set further cut-off currents below I_{TO,1} and above the original I_{TO,1}. Same as in ZOS, the further cut-off currents are switched with the lowest switching losses and without cut-off overvoltages, or in the context of admissible tolerances. With further cut-off currents, a power electronic converter system can set the power range with ZOS more easily.

According to an embodiment, the capacitance element may additively act on an electric capacitance value to increase the same and/or a parasitic inductance of the capacitance element of a circuit path described herein may decrease an effective electric inductance value of an intermediate circuit associated with the commutation circuit.

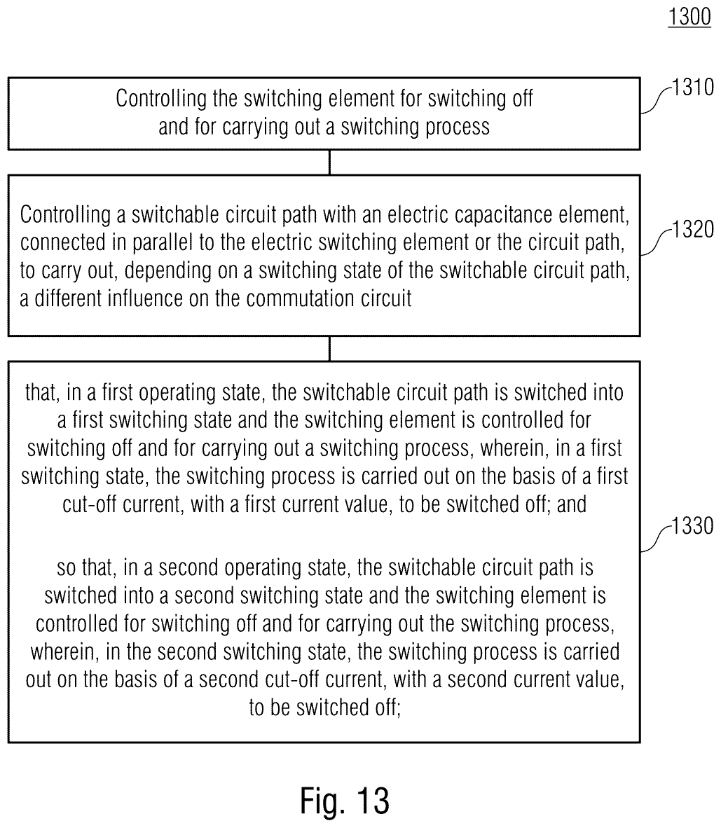

FIG. 13 shows a schematic flow diagram of a method 1300 according to an embodiment, which may be used for controlling an apparatus described herein, having a switch arrangement with at least one switching element equipped for cutting off an electric current path of a commutation circuit. The commutation circuit comprises a free-wheeling element with a capacitance effective in parallel. Step 1310 includes controlling the switching element for cutting off and for carrying out a switching process. Step 1320 includes controlling a switchable circuit path with an electric capacitance element, connected in parallel to the electric switching element or the circuit path, so as to carry out, depending on a switching state of the switchable circuit path, a different influence on the commutation circuit. Step 1320 may be carried out prior to, after, or simultaneously with step 1310. The method is carried out such that, in an implementation 1330, in a first operating state, the switchable circuit path is switched into a first switching state and the switching element is controlled for cutting off and for carrying out a switching process, wherein the switching process is carried out in a first switching state on the basis of a first cut-off current, with a first current value, to be cut off. In a second operating state, the switchable circuit path is switched into a second switching state and the switching element is controlled for cutting off and for carrying out the switching process, wherein the switching process is carried out in a second switching state on the basis of a second cut-off current, with a second current value, to be cut off.

The method 1300 may be available as a program code or as a computer program with such a program code, for performing the method, if the program runs on a computing unit, e.g. but not necessarily, on a non-volatile storage medium. Some embodiments include that a computing unit is provided with a program code for performing the method 1300, such as a field-programmable gate array, FPGA, microcontrollers, an application specific integrated circuit, ASICs, and/or using a microcontroller.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

Depending on specific implementation requirements, embodiments of the invention may be implemented in hardware or in software. Implementation may be effected while using digital signal processing circuits such as microcontrollers, ASICs, and/or in, FPGAs and/or using a digital storage medium.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] https://patents.google.com/patent/US6341073B1l/en
[2] https://patentimages.storage.google-apis.com/88/2b/b8/045df8edc53ad2/US20080175029A1.pdf
[3] https://ieeexplore.ieee.org/stamp/stamp.jsp?tp=&arnumber=4267791

1. Apparatus, comprising:
a switch arrangement with at least one switching element configured for cutting off an electric current path of a commutation circuit, wherein the commutation circuit comprises a free-wheeling element with a capacitance effective in parallel;
a switchable circuit path, connected or coupled in parallel to the electric switching element or to the circuit path, with an electric capacitance element configured to cause, depending on a switching state of the switchable circuit path, a different influence on the commutation resonant circuit,
a driving unit configured to
switch, in a first operating state, the switchable circuit path into a first switching state and to control the switching element for cutting off and for carrying out a switching process, wherein, in the first switching state, the switching process is carried out on the basis of a first cut-off current with a first current value, to be cut off; and
switch, in a second operating state, the switchable circuit path into a second switching state and to control the switching element for cutting off and for carrying out the switching process, wherein, in the second switching state, the switching process is carried out on the basis of the second cut-off current, with a second current value, to be cut off.

2. Apparatus according to claim 1, wherein the driving unit is configured to switch, on the basis of a cut-off current to be cut off, flowing through the switching element when carrying out the switching, the switchable circuit path into the first state or into the second state as a state to be set.

3. Apparatus according to claim 2, wherein the state to be set is associated with a lower cut-off overvoltage at the switching element.

4. Apparatus according to claim 3, wherein the capacitor element is connected in parallel to the current path and is configured to adapt, on the basis of an electric inductance of the capacitance element, an effective inductance of an intermediate circuit associated with the commutation circuit.

5. Apparatus according to claim 4, wherein the inductance value of the capacitance element is lower than 50 nH.

6. Apparatus according to claim 4, wherein the capacitance element comprises a ceramic capacitor element or a foil capacitor element providing an electric inductance value and an electric capacitance value.

7. Apparatus according to claim 4, wherein the driving unit is configured for an operating state in which the switching process is carried on the basis of a cut-off current to be cut off, if the following is fulfilled in an idealized manner within a tolerance range:
$${I}_{TO , n} = \{ \begin{matrix}\frac{{V}_{D C} \sqrt{\frac{{( {C}_{eff 1} + {C}_{eff 2} )}^{3}}{{C}_{eff 1} {C}_{eff 2} {L}_{σ}}}}{n π} & {T}_{aic} = 0 \\ \frac{{V}_{D C} \sqrt{\frac{{( {C}_{eff 1} + {C}_{eff 2} )}^{3}}{{C}_{eff 1} {C}_{eff 2} ( {L}_{σ , 1} + \frac{{L}_{a ic} {L}_{σ , 2}}{{L}_{a ic} + {L}_{σ , 2}} )}}}{n π} & {T}_{aic} = 1\end{matrix}$$
wherein I_{TO,n} describes the cut-off currents, to be cut off, through the switching element, V_{DC} describes an intermediate circuit voltage of the commutation circuit, C_{eff1} describes an effective capacitance, associated with the switching element, of the commutation resonant circuit, C_{eff2} describes an effective capacitance, associated with the free-wheeling element, of the commutation resonant circuit, L_{σ} describes an effective electric inductance of the commutation resonant circuit, L_{σ1} describes a parasitic inductance of the commutation circuit, L_{σ2} describes a parasitic inductance of an intermediate circuit associated with the commutation circuit, L_{aic} describes an electric inductance of the switchable circuit path, T_{aic}=0 describes a non-conductive state of the switchable circuit path, T_{aic}=1 describes a conductive state of the switchable circuit path, and n describes a natural number in the space n=2i+1 with i∈ [symbol] ₀.

8. Apparatus according to claim 1, wherein the capacitance element is connected in parallel to the switching element to adapt an effective capacitance of the switching element.

9. Apparatus according to claim 8, wherein the driving unit is configured for an operating state in which the switching process is carried on the basis of a cut-off current to be cut off, if the following is fulfilled in an idealized manner within a tolerance range:
$${I}_{TO , n} = \{ \begin{matrix}\frac{{V}_{D C} \sqrt{\frac{{( {C}_{eff 1} + {C}_{eff 2} )}^{3}}{{C}_{eff 1} {C}_{eff 2} {L}_{σ}}}}{n π} & {T}_{acc 1} = 0 ∧ {T}_{acc 2} = 0 \\ \frac{{V}_{D C} \sqrt{\frac{{( {C}_{eff 1} + {C}_{acc 1} + {C}_{eff 2} )}^{3}}{( {C}_{eff 1} + {C}_{acc 1} ) {C}_{eff 2} {L}_{σ}}}}{n π} & {T}_{acc 1} = 1 ∧ {T}_{acc 2} = 0 \\ \frac{{V}_{D C} \sqrt{\frac{{( {C}_{eff 1} + {C}_{eff 2} + {C}_{acc 2} )}^{3}}{{C}_{eff 1} ( {C}_{eff 2} + {C}_{acc 2} ) {L}_{σ}}}}{n π} & {T}_{acc 1} = 0 ∧ {T}_{acc 2} = 1 \\ \frac{{V}_{D C} \sqrt{\frac{{( {C}_{eff 1} + {C}_{acc 1} + {C}_{eff 2} + {C}_{acc 2} )}^{3}}{( {C}_{eff 1} + {C}_{acc 1} ) ( {C}_{eff 2} + {C}_{acc 2} ) {L}_{σ}}}}{n π} & {T}_{acc 1} = 1 ∧ {T}_{acc 2} = 1\end{matrix}$$
wherein I_{TO,n} describes the cut-off currents, to be cut off, through the switching element, V_{DC} describes an intermediate circuit voltage of the commutation circuit, C_{eff1} describes an effective capacitance, associated with the switching element, of the commutation resonant circuit, C_{eff2} describes an effective capacitance, associated with the free-wheeling element, of the commutation resonant circuit, L_{σ} describes an effective electric inductance of the commutation resonant circuit, C_{acc1} describes an electric capacitance, effective in parallel to C_{eff1}, of the switchable circuit path, C_{acc2} is an electric capacitance, effective in parallel to C_{eff2}, of the switchable circuit path; T_{acc}=0 describes a non-conductive state of the second switchable circuit path, T_{acc}=1 describes a conductive state of the second switchable circuit path, and n describes a natural number in the space n=2i+1, with i∈ [symbol] ₀;

10. Apparatus according to claim 1, wherein switchable circuit path is a first switchable circuit path, wherein the capacitor element is connected in parallel to the current path and an electric inductance of the capacitance element is configured to adapt an effective inductance of an intermediate circuit associated with the commutation circuit; and
a second switchable circuit path comprising a second capacitance element connected in parallel to the switching element is coupled to adapt an effective capacitance of the switching element.

11. Apparatus according to claim 10, wherein the driving unit is configured for an operating state in which the switching process is carried on the basis of a cut-off current to be cut off, if the following is fulfilled in an idealized manner within a tolerance range:
$${I}_{TO , n} = \{ \begin{matrix}\frac{{V}_{D C} \sqrt{\frac{{( {C}_{eff 1} + {C}_{eff 2} )}^{3}}{{C}_{eff 1} {C}_{eff 2} {L}_{σ}}}}{n π} & {T}_{acc 1} = 0 ∧ {T}_{acc 2} = 0 ∧ {T}_{aic} = 0 \\ \frac{{V}_{D C} \sqrt{\frac{{( {C}_{eff 1} + {C}_{eff 2} )}^{3}}{{C}_{eff 1} {C}_{eff 2} ( {L}_{σ , 1} + \frac{{L}_{aic} {L}_{σ , 2}}{{L}_{aic} + {L}_{σ , 2}} )}}}{n π} & {T}_{acc 1} = 0 ∧ {T}_{acc 2} = 0 ∧ {T}_{aic} = 1 \\ \frac{{V}_{D C} \sqrt{\frac{{( {C}_{eff 1} + {C}_{eff 2} + {C}_{acc 2} )}^{3}}{{C}_{eff 1} ( {C}_{eff 2} + {C}_{acc 2} ) {L}_{σ}}}}{n π} & {T}_{acc 1} = 0 ∧ {T}_{acc 2} = 1 ∧ {T}_{aic} = 0 \\ \frac{{V}_{D C} \sqrt{\frac{{( {C}_{eff 1} + {C}_{eff 2} + {C}_{acc 2} )}^{3}}{{C}_{eff 1} ( {C}_{eff 2} + {C}_{acc 2} ) ( {L}_{σ , 1} + \frac{{L}_{aic} {L}_{σ , 2}}{{L}_{aic} + {L}_{σ , 2}} )}}}{n π} & {T}_{acc 1} = 0 ∧ {T}_{acc 2} = 1 ∧ {T}_{aic} = 1 \\ \frac{{V}_{D C} \sqrt{\frac{{( {C}_{eff 1} + {C}_{acc 1} + {C}_{eff 2} )}^{3}}{( {C}_{eff 1} + {C}_{acc 1} ) {C}_{eff 2} {L}_{σ}}}}{n π} & {T}_{acc 1} = 1 ∧ {T}_{acc 2} = 0 ∧ {T}_{aic} = 0 \\ \frac{{V}_{D C} \sqrt{\frac{{( {C}_{eff 1} + {C}_{acc 1} + {C}_{eff 2} )}^{3}}{( {C}_{eff 1} + {C}_{acc 1} ) {C}_{eff 2} ( {L}_{σ , 1} + \frac{{L}_{aic} {L}_{σ , 2}}{{L}_{aic} + {L}_{σ , 2}} )}}}{n π} & {T}_{acc 1} = 1 ∧ {T}_{acc 2} = 0 ∧ {T}_{aic} = 1 \\ \frac{{V}_{D C} \sqrt{\frac{{( {C}_{eff 1} + {C}_{acc 1} + {C}_{eff 2} + {C}_{acc 2} )}^{3}}{( {C}_{eff 1} + {C}_{acc 1} ) ( {C}_{eff 2} + {C}_{acc 2} ) {L}_{σ}}}}{n π} & {T}_{acc 1} = 1 ∧ {T}_{acc 2} = 1 ∧ {T}_{aic} = 0 \\ \frac{{V}_{D C} \sqrt{\frac{{( {C}_{eff 1} + {C}_{acc 1} + {C}_{eff 2} + {C}_{acc 2} )}^{3}}{( {C}_{eff 1} + {C}_{acc 1} ) ( {C}_{eff 2} + {C}_{acc 2} ) ( {L}_{σ , 1} + \frac{{L}_{aic} {L}_{σ , 2}}{{L}_{aic} + {L}_{σ , 2}} )}}}{n π} & {T}_{acc 1} = 1 ∧ {T}_{acc 2} = 1 ∧ {T}_{aic} = 1\end{matrix}$$
wherein I_{TO,n} describes the cut-off current, to be cut off, through the switching element, V_{DC} describes an intermediate circuit voltage of the commutation circuit, C_{eff1} describes an effective capacitance, associated with the switching element, of the commutation resonant circuit, C_{eff2} describes an effective capacitance, associated with the free-wheeling element, of the commutation resonant circuit,
L_{σ1} describes a parasitic inductance of the commutation circuit, L_{σ2} describes a parasitic inductance of an intermediate circuit associated with the commutation circuit, L_{aic} describes an electric inductance of the first switchable circuit path, C_{acc1} describes an electric capacitance, effective in parallel to C_{eff1}, of the switchable circuit path, C_{acc2} describes an electric capacitance, effective in parallel to C_{eff2}, of the switchable circuit path and n describes a natural number in the space n=2i+1, with i∈ [symbol] ₀;
wherein T_{aic}=0 designates a non-conductive state of the first switchable circuit path, T_{aic}=1 designates a conductive state of the first switchable circuit path; T_{acc1} or T_{acc}=0 designates a non-conductive state of the second switchable circuit path, T_{acc1} or T_{acc}=1 designates a conductive state of the second switchable circuit path.

12. Apparatus according to claim 1, wherein the switchable circuit path comprises a path circuit element for switching the switchable circuit path.

13. Apparatus according to claim 1, wherein the switchable circuit path is one of a plurality of switchable circuit paths coupled in parallel, wherein the driving unit is configured to individually drive each of the plurality of switchable circuit paths;
wherein each of the combination of switching states of the plurality of switchable circuit paths is associated with a current/voltage characteristic curve of the apparatus with respect to an output current or input current to the set with the switching process and a current flowing through the switching element when carrying out the switching;
wherein the driving unit is configured, on the basis of an input current or output current of the apparatus and depending on an intermediate circuit voltage, to select the cut-off current and to set the combination of switching states on the basis of the cut-off current.

14. Apparatus according to claim 13, wherein the driving unit is coupled to a data storage element comprising information associated with an output current to be provided by the apparatus or an output voltage to be provided by the apparatus on the one hand and the combination of switching states on the other hand; wherein the driving unit is configured, on the basis of the current flowing through the switching element when carrying out the switching, read the combination of switching states from the data storage element and set the same.

15. Apparatus according to claim 1, wherein the driving unit is configured, for the switching process, to switch the switching element with a channel cut-off duration that is shorter than a period duration of a resonance oscillation of the commutation circuit so as to excite an oscillation in the commutation circuit.

16. Apparatus according to claim 1, wherein the driving unit is configured to leave a state of the switchable circuit path for swapping changing an operating state of the apparatus unchanged and to leave the apparatus unchanged during the operating state and switch the switching element several times during that.

17. Apparatus according to claim 1, wherein the switching element and a switch of the switchable circuit path comprise a n-MOSFET, or a GaN-based transistor with high electron mobility, GaN-HEMT, wherein switches formed in any other way, preferably but not necessarily semiconductor switches, are not excluded.

18. Apparatus according to claim 1, wherein the capacitance element additively acts on an electric capacitance value to increase the same or a parasitic inductance of the capacitance element of a circuit path decreases an effective electric inductance value of an intermediate circuit associated with the commutation circuit.

19. Method for controlling an apparatus described herein, with a switch arrangement with at least one switching element equipped for cutting off an electric current path of a commutation circuit, wherein the commutation circuit comprises a free-wheeling element with a capacitance effective in parallel, comprising:
controlling the switching element for cutting off and for carrying out a switching process;
controlling a switchable circuit path with an electric capacitance element, connected in parallel to the electric switching element or the circuit path, so as to carry out, depending on a switching state of the switchable circuit path, a different influence on the commutation resonant circuit;
so that, in a first operating state, the switchable circuit path is switched into a first switching state and the switching element is controlled for cutting off and for carrying out a switching process, wherein the switching process is carried out in a first switching state on the basis of a first cut-off current, with a first current value, to be cut off; and
in a second operating state, the switchable circuit path is switched into a second switching state and the switching element is controlled for cutting off and for carrying out the switching process, wherein the switching process is carried out in a second switching state on the basis of a second cut-off current, with a second current value, to be cut off.

20. A non-transitory digital storage medium having a computer program stored thereon to perform the method for controlling an apparatus described herein, with a switch arrangement with at least one switching element equipped for cutting off an electric current path of a commutation circuit, wherein the commutation circuit comprises a free-wheeling element with a capacitance effective in parallel, comprising:
controlling the switching element for cutting off and for carrying out a switching process;
controlling a switchable circuit path with an electric capacitance element, connected in parallel to the electric switching element or the circuit path, so as to carry out, depending on a switching state of the switchable circuit path, a different influence on the commutation resonant circuit;
so that, in a first operating state, the switchable circuit path is switched into a first switching state and the switching element is controlled for cutting off and for carrying out a switching process, wherein the switching process is carried out in a first switching state on the basis of a first cut-off current, with a first current value, to be cut off; and
in a second operating state, the switchable circuit path is switched into a second switching state and the switching element is controlled for cutting off and for carrying out the switching process, wherein the switching process is carried out in a second switching state on the basis of a second cut-off current, with a second current value, to be cut off,
when said computer program is run by a computer.
